(19) United States
(12) Patent Application Publication
(10) Pub. No.: US 2026/0330703 A1
(43) Pub. Date: Oct. 22, 2026

(54) SYSTEMS AND METHODS FOR GENERATIVE OBJECT COMPOSITING

(71) Applicant: ADOBE INC., SAN JOSE, CA (US)

(72) Inventors: Soo Ye Kim, Los Angeles, CA (US); He Zhang, Santa Clara, CA (US); Mengwei Ren, San Jose, CA (US); Ruxuan Kuang, San Jose, CA (US); Yuqian Zhou, Redmond, WA (US); Zhifei Zhang, San Jose, CA (US); Scott Cohen, Cupertino, CA (US); Betty Leong, Los Altos, CA (US); HyunJoon Jung, Monte Sereno, CA (US); Zhe Lin, Clyde Hill, WA (US)

(21) Appl. No.: 19/331,118

(22) Filed: Sep. 17, 2025

Related U.S. Application Data
(60) Provisional application No. 63/791,150, filed on Apr. 18, 2025.

(51) Int. Cl. G06T 11/00; G06T 5/60; G06T 5/70

(52) U.S. Cl. CPC G06T 11/00; G06T 5/60; G06T 5/70; G06T 2207/20081; G06T 2207/20084

(57) ABSTRACT

A method, apparatus, non-transitory computer readable medium, and system for image generation include obtaining an input image and a reference image, where the input image depicts a scene and the reference image depicts an object, encoding the reference image to obtain a harmonization embedding and an identity embedding, where the harmonization embedding represents semantic information about the object and the identity embedding represents an identity of the object, and generating a synthetic image based on the input image, the harmonization embedding, and the identity embedding, where the synthetic image depicts the object from the reference image in the scene from the input image and preserves the identity of the object.

### CROSS-REFERENCE TO RELATED APPLICATION

This application claims priority under 35 U.S.C. § 119 to U.S. Provisional Application No. 63/791,150, filed on Apr. 18, 2025, in the United States Patent and Trademark Office, the disclosure of which is incorporated by reference herein in its entirety.

### BACKGROUND

The following relates generally to image generation using machine learning, and more specifically to generative object compositing. Machine learning is a field of data processing that focuses on building algorithms capable of learning from and making predictions or decisions based on data. Machine learning includes a variety of techniques, ranging from simple linear regression to complex neural networks, and plays a significant role in automating and optimizing tasks that would otherwise require extensive human intervention.

Generative models in machine learning are algorithms designed to generate new data samples, such as images, that resemble a given dataset. Object compositing is an image generation sub-field in which pixels representative of an object depicted in an image are inserted into another image (in many cases, with a goal of creating a new image that realistically incorporates the object with the other image).

### SUMMARY

Systems and methods are described for generative object compositing. In one example, an image generation model generates a synthetic image in which pixels representative of an object from a reference image are naturally blended with a scene from an input image, such that the color and lighting of the object and the scene are harmonized, a geometry or view of the object and the scene are matched, an accurate shadow for the object is synthetized, and edges of the object are accurately blended with the scene.

In some embodiments, the image generation model generates the synthetic image based on a harmonization embedding and an identity embedding of the reference image. The harmonization embedding encourages the synthetic image to realistically and accurately incorporate the object with the scene in the synthetic image, while the identity embedding encourages the synthetic image to maintain identifying visual characteristics of the object in the synthetic image, irrespective of a change in lighting, color, size, shape, pose, shadow, etc. with which the object is depicted in the synthetic image.

In some embodiments, the image generation model is trained using both an unmasked input image and a masked input image (e.g., an image that includes a masked region), thereby allowing the image generation model to generate a synthetic image based on either an unmasked input image or a masked input image input at inference time. When the image generation model generates the synthetic image based on the unmasked input image, the newly generated pixels included in the synthetic image depict the object, while the remaining pixels are maintained from the unmasked input image. When the image generation model generates the synthetic image based on the masked input image, the newly generated pixels included in the synthetic image depict the object and additional background content, while the remaining pixels are maintained from the masked input image.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The Detailed Description is described with reference to the accompanying figures. Entities represented in the figures are indicative of one or more entities and thus reference is made interchangeably to single or plural forms of the entities in the discussion.

FIG. 1 shows an example of an image generation system according to aspects of the present disclosure.

FIG. 2 shows an example of a method for generating a synthetic image according to aspects of the present disclosure.

FIG. 3 shows an example of synthetic images according to aspects of the present disclosure.

FIG. 4 shows an example of synthetic images depicting a virtual-try on according to aspects of the present disclosure.

FIG. 5 shows an example of a synthetic image depicting a background replacement according to aspects of the present disclosure.

FIG. 6 shows an example of a synthetic image depicting an environmental object replacement according to aspects of the present disclosure.

FIG. 7 shows an example of a synthetic image depicting a texture replacement according to aspects of the present disclosure.

FIG. 8 shows an example of a synthetic image depicting a creative generated object according to aspects of the present disclosure

FIG. 9 shows an example of an image generation model for generating a synthetic image based on a scene input image according to aspects of the present disclosure.

FIG. 10 shows an example of an image generation model for generating a synthetic image based on a masked input image according to aspects of the present disclosure.

FIG. 11 shows an example of a guided latent diffusion model according to aspects of the present disclosure.

FIG. 12 shows an example of a U-Net according to aspects of the present disclosure.

FIG. 13 shows an example of a diffusion transformer architecture according to aspects of the present disclosure.

FIG. 14 shows an example of a method for generating a synthetic image according to aspects of the present disclosure.

FIG. 15 shows an example of a diffusion process according to aspects of the present disclosure.

FIG. 16 shows an example of a method for training a machine learning model according to aspects of the present disclosure.

FIG. 17 shows an example of a flow diagram depicting an algorithm as a step-by-step procedure for training a machine learning model according to aspects of the present disclosure.

FIG. 18 shows an example of a diagram for training an image generation model using a scene input image according to aspects of the present disclosure.

FIG. 19 shows an example of a diagram for training an image generation model using a masked input image according to aspects of the present disclosure.

FIG. 20 shows an example of an image extraction model according to aspects of the present disclosure.

FIG. 21 shows a comparative example of an image generated based on a fine-tuned identity encoder according to aspects of the present disclosure.

FIG. 22 shows an example of the effect of mask randomization during training according to aspects of the present disclosure.

FIG. 23 shows an example of a method for training a diffusion model according to aspects of the present disclosure.

FIG. 24 shows an example of a computing device according to aspects of the present disclosure.

FIG. 25 shows an example of an image generation apparatus according to aspects of the present disclosure.

### DETAILED DESCRIPTION

### Overview

Object compositing, a core image editing task, includes compositing an object depicted in a reference image into an input image to obtain a composite image. A current object compositing pipeline includes copying and pasting the object from the reference image into a scene from the input image to obtain a composite image, applying relighting to the object match the lighting in the scene, harmonizing the color of the object to match the scene, blending the boundaries of the object with the scene, removing original pixels in the scene, and inserting a synthetic shadow below the object in the scene.

This current pipeline involves many steps requiring manual work, making it challenging for the user to obtain a realistic composite image. Furthermore, the current pipeline does not account for a mismatch in a perspective/geometry/view/pose of the object with the input image, leading to an unnatural looking result. For example, accurately compositing a car depicted from a side view into a road depicted from a front view would require rotating the car in three dimensions to align with the perspective of the road, which is not achievable with current image compositing tools.

Accordingly, aspects of the present disclosure directly generate a synthetic image in which pixels representative of an object from a reference image are naturally blended with a scene from an input image, such that the color and lighting of the object and the scene are harmonized, a geometry or view of the object and the scene are matched, an accurate shadow for the object is synthetized, and edges of the object are accurately blended with the scene.

Aspects of the present disclosure provide generative object compositing systems and methods that achieve one or more of color harmonization (e.g., recoloring of an object to match a scene), lighting harmonization (e.g., relighting of an object to match a scene), perspective matching of an object to a scene (e.g., matching a top-view object to a side-view scene), pose adaptation of an object based on a context of a scene (e.g., a jacket composited onto a person should appear as if the person is wearing the jacket, or a standing person composited onto a chair should appear to be sitting on the chair), object effect generation (e.g., natural shadow and reflection generation consistent to scene lighting), physical effect generation based on a context of a scene (e.g., an object composited onto a deformable surface such as sand or grass should appear to deform the surface, an object composted onto water may appear to cause water ripples in the water surface), edge blending (e.g., removing pixels from the scene and blending the edges of the object with the scene), and size harmonization (e.g., resizing the object to match the scene), along with identity preservation of the original object (e.g., maintaining distinct visual characteristic(s) of the object in the composite image).

### Terminology Examples

An “input image” refers to an image depicting a scene. A “scene” refers to any or all objects or elements depicted in an input image. An example input image may depict a scene comprising a field, a mountain, and a sky. In some embodiments, an input image comprises a background image.

A “reference image” refers to an image depicting an object. An “object” is any discrete element depicted in an image. An example reference image may depict a bird, where the bird is the object. In some embodiments, a reference image only depicts an object and omits a depiction of any other object. In an example, a reference image depicts an object against a monotone (e.g., black or white) or transparent background. In some embodiments, a reference image comprises a foreground image.

A “masked input image” refers to an input image including a masked region (e.g., a group of one or more contiguous monochrome pixels). A “scene input image” refers to an input image that omits a masked region. A “input image mask” refers to an input, such as an image, depicting or otherwise denoting a masked region and a non-masked region (e.g., an additional group of one or more contiguous monochrome pixels), where a color of the masked region is different than (e.g., opposite from) a color of the non-masked region.

An “encoding” or “embedding” is a representation of an object in a lower-dimensional space such that information about the object is more easily captured and analyzed by a machine learning model. For example, the embedding is a numerical representation of the object in a continuous vector space in which objects that include similar information to each other correspond to vectors that are numerically similar and thus “closer” to each other, thereby allowing a similarity between different objects corresponding to different embeddings to be readily determined.

An “embedding space” (or a “vector space”) refers to a mathematical set having embeddings (or vectors) as components and is characterized by a dimension specifying a number of independent directions in the embedding space.

A “harmonization embedding” refers to an embedding generated by a harmonization encoder. In some embodiments, a harmonization embedding represents semantic information about an image or an object depicted in an image. “Semantic information” of an object refers to information that imparts knowledge of a “meaning” of the object.

A “identity embedding” refers to an embedding generated by an identity encoder. In some embodiments, an identity embedding represents an identity of an object. An identity of an object refers to one or more visual characteristics of an object that enable a viewer of the object to identify the object. In some cases, an identity of an object is independent of one or more of a pose, color, lighting, shadow, or orientation of the object.

A “synthetic image” refers to an image generated by the machine learning model. A “noise map” refers to random noise such as a noise vectors that is fed into the image generation model to generate the synthetic image. The noise maps helps to generate diverse and realistic outputs by introducing randomness into the generation process.

An example of the present disclosure is used in an object compositing context for compositing an object into a scene input image. In the example, a user provides an image generation system with a reference image depicting a bird; an input image depicting a scene including mountain, a field, and a sky; and a mask indicating a location for the bird to be composited into the sky of the scene. The image generation system generates a harmonization embedding and an identity embedding based on the reference image, and generates a synthetic image based on the harmonization embedding, the identity embedding, the input image, and the mask using an image generation model, such as a diffusion model. The harmonization embedding and the identity embedding enable the image generation model to accurately depict the bird in the scene at a location dictated by the mask, such that a color, lighting, perspective, shadow, and pose of the bird match the scene.

Furthermore, because the image generation model may be trained using scene input images (e.g., input images that omit a masked region), the separate input image and input image mask inputs enable the image generation model to maintain pixels from the original scene in an area of the synthetic image corresponding to the masked area.

Another example of the present disclosure is used in an object compositing context for compositing an object into a masked input image. In the example, a user provides an image generation system with a reference image depicting a bird and a masked input image depicting a scene including mountain, a field, and a sky, and a masked portion indicating a location for the bird to be composited into the sky of the scene. The image generation system generates a harmonization embedding and an identity embedding based on the reference image, and generates a synthetic image based on the harmonization embedding, the identity embedding, and the masked input image using an image generation model, such as a diffusion model. The harmonization embedding and the identity embedding enable the image generation model to accurately depict the bird in the scene at a location dictated by the masked portion, such that a color, lighting, perspective, shadow, and pose of the bird match the scene.

Furthermore, because the image generation model may be trained using masked input images, the separate input image and input image mask inputs enable the image generation model to generate new content for the original scene in an area of the synthetic image corresponding to the masked area.

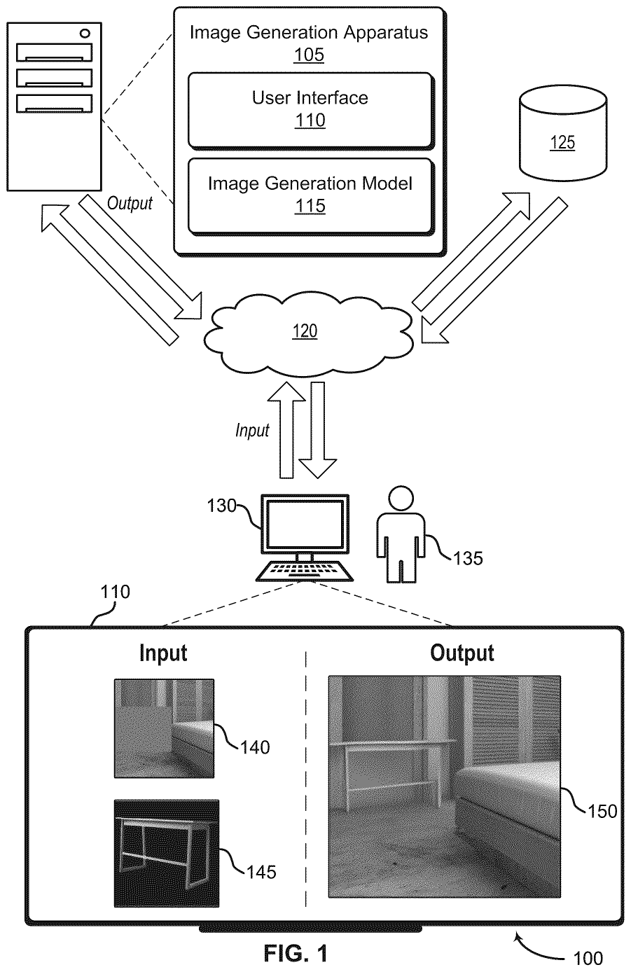

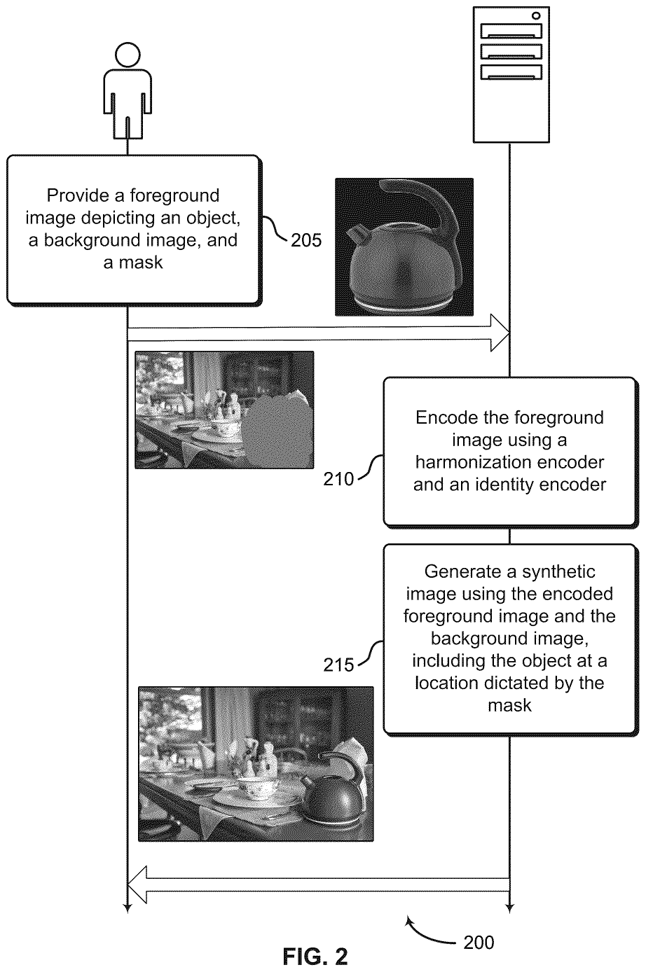

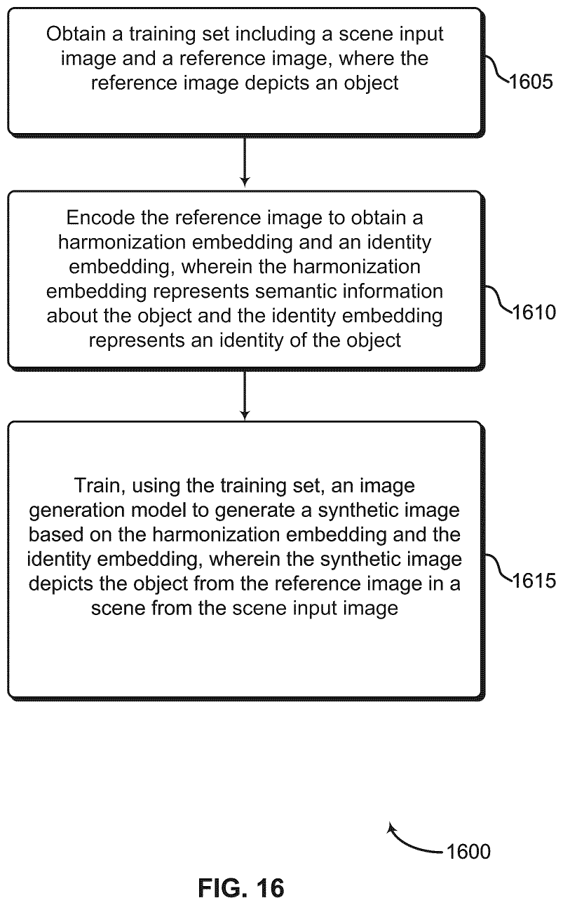

Further examples of the present disclosure in an object compositing context are provided with reference to FIGS. 1-8. Details regarding the architecture of the image generation system are provided with reference to FIGS. 1, 3-13, and 24-25. Examples of a process for generating a synthetic image are provided with reference to FIGS. 2 and 14-15. Examples of a process for training a machine learning model are provided with reference to FIGS. 16-23.

Embodiments of the disclosure improve on conventional machine learning technology by increasing the accuracy and efficiency of object compositing. For example, some embodiments achieve this efficiency and accuracy by using a harmonization encoder and an identity encoder to generate respective embeddings of a reference image, and using an image generation model to generate a synthetic image depicting an object from the reference image in a scene of an input image based on an embedding of the input image and the embeddings generated by the harmonization encoder and the identity encoder. Generating the synthetic image based on the embeddings generated by the harmonization encoder and the identity encoder enable accurate harmonization of the object with the scene while maintaining an identity of the object, while efficiently avoiding manual manipulation of the reference image or the input image.

In some cases, the harmonization encoder comprises an image encoder trained together with a text encoder to generate an embedding of an image in a multi-modal embedding space, while the identity encoder comprises an image encoder trained based on unlabeled images. Accordingly, the harmonization embedding includes more semantic-level information about the reference image (e.g., how the reference image could be described using text) than pixel-level image information, while the identity embedding includes identity-related information about the reference image. Therefore, a combination of the harmonization embedding and the identity embedding allows the image generation model to accurately harmonize the reference image with the input image while maintaining an identity of the reference image.

By contrast, some conventional approaches to object compositing include a multi-step, manual pipeline of inserting an object into a scene and then manipulating visual characteristics of the object to match the scene, which is inefficient and inaccurate (especially in cases that involve reposing the object). Some other conventional approaches to object compositing may include generating a composite image using a diffusion model based on a scene image and an object image, but because these conventional approaches lack guidance that effectively provides both semantic and identity-level information about the object image, the composite image does not accurately depict an object composited into a scene.

Furthermore, some embodiments of the present disclosure achieve this efficiency and accuracy by training the image generation model using both scene input images and masked input images. The image generation model is therefore able to generate a new background scene or maintain a background scene in a synthetic image in accordance with goals of a user. By contrast, conventional image generation systems may not be able to maintain a portion of an original scene from an input image in a synthetic image where that portion corresponds to pixels of a mask input, or may not be able to either generate a new background scene or maintain a background scene in a synthetic image depending on inputs at inference time.

Still further, some embodiments of the present disclosure achieve this efficiency and accuracy by training the image generation model using different random masks. The random masks provide diverse object location targets for the image generation model during training, resulting in training data that enables the image generation model to learn to generate synthetic images that accurately harmonize an object with a scene.

Additionally, the present disclosure describes systems and methods that improve on conventional machine learning systems by making a generative object compositing process more accurate. For example, a synthetic image generated using the image generation model based on a harmonization embedding and an identity embedding of a reference image is more accurate than an image generated by a conventional diffusion model based on the reference image. Furthermore, training the image generation model based on masked input images and unmasked input images enables the image generation model, unlike conventional image generation models, to dictate whether a synthetic composite image includes new background content at inference time based on a masked or unmasked background input.

### Image Generation System

FIG. 1 shows an example of an image generation system 100 according to aspects of the present disclosure. The example shown includes image generation system 100, user device 130, user 135, masked input image 140, reference image 145, and synthetic image 150. In one aspect, image generation system 100 includes image generation apparatus 105, cloud 120, and database 125. In one aspect, image generation apparatus 105 includes user interface 110 and image generation model 115.

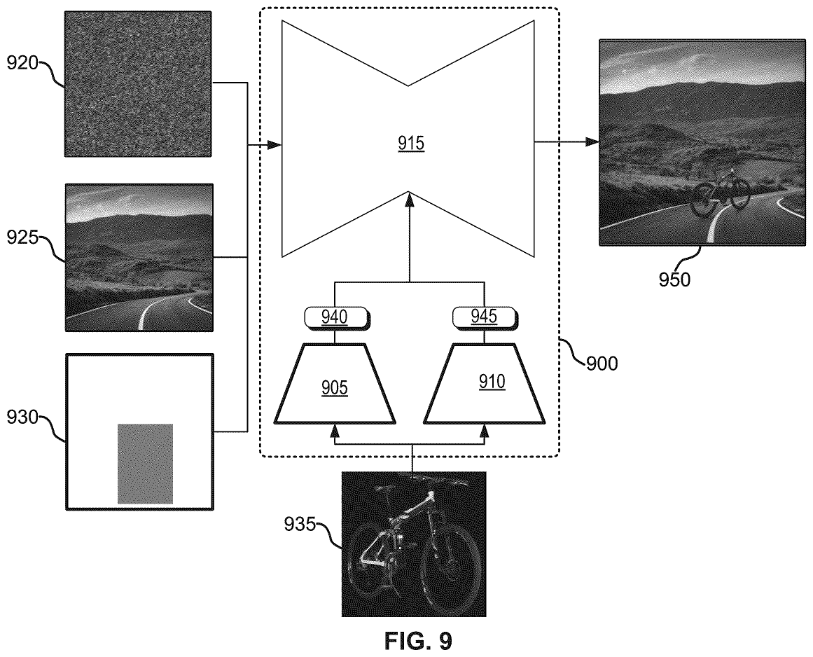

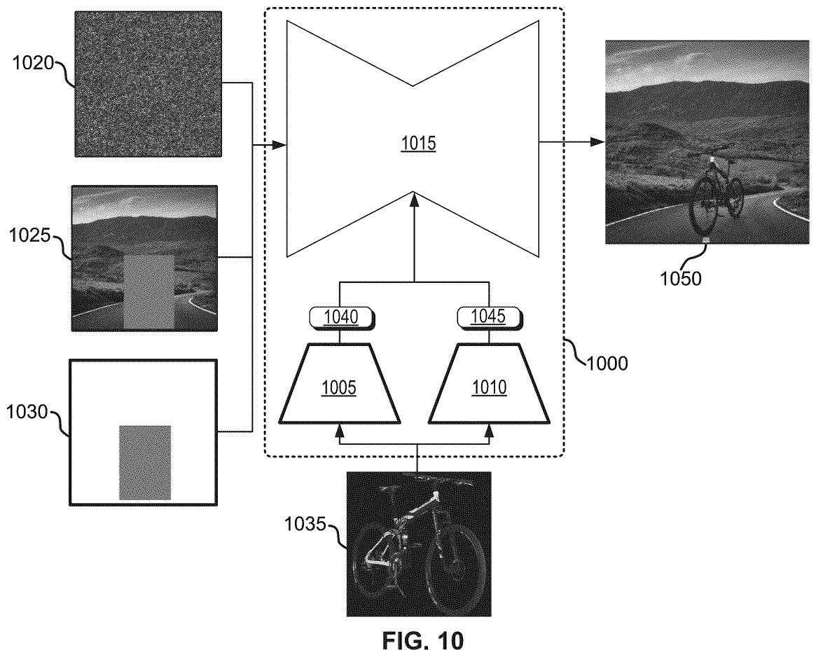

Referring to FIG. 1, a user (e.g., user 135) provides an input including an input image depicting a scene (such as masked input image 140) and a reference image depicting an object (e.g., reference image 145) to image generation apparatus 105 via user interface 110 displayed on a user device (e.g., user device 130) by image generation apparatus 105. Image generation apparatus 105 generates a synthetic image depicting the object composited into the scene (e.g., synthetic image 150) based on the input image and the reference image as described in further detail with reference to FIG. 9 or 10. User interface 110 displays the synthetic image to the user.

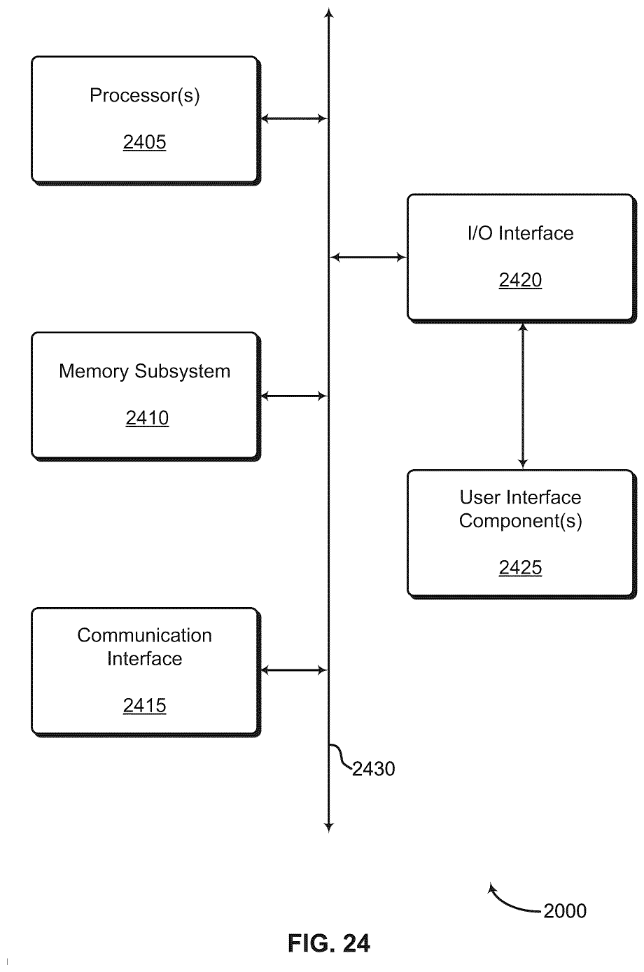

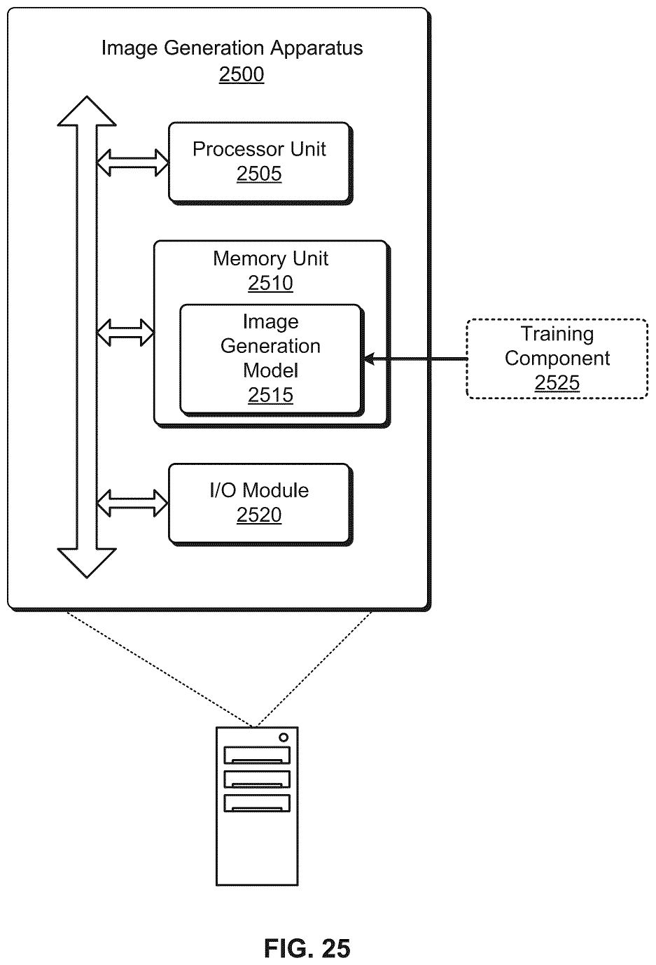

Image generation apparatus 105 is an example of, or includes aspects of, the corresponding element described with reference to FIGS. 24 and 25. According to some aspects, image generation apparatus 105 includes a computer-implemented network. In some embodiments, the computer-implemented network includes image generation model 115. Image generation apparatus 105 may also include one or more processors, a memory subsystem, a communication interface, an I/O interface, one or more user interface components, and a bus as described with reference to FIG. 24. Additionally, image generation apparatus 105 may communicate with the user device and database 125 via cloud 120.

According to some aspects, image generation apparatus 105 is implemented on a server. A server provides one or more functions to users linked by way of one or more of various networks, such as cloud 120. The server may include a microprocessor board that includes a microprocessor responsible for controlling all aspects of the server. The server uses the microprocessor and protocols such as hypertext transfer protocol (HTTP), simple mail transfer protocol (SMTP), file transfer protocol (FTP), and simple network management protocol (SNMP) to exchange data with other devices or users on one or more of the networks. The server may be configured to send and receive hypertext markup language (HTML) formatted files (e.g., for displaying web pages). In various embodiments, the server comprises a general-purpose computing device, a personal computer, a laptop computer, a mainframe computer, a supercomputer, or any other suitable processing apparatus.

User interface 110 allows information to be communicated between the user and image generation apparatus 105. According to some aspects, user interface 110 comprises a text interface, a graphical user interface, or a combination thereof. According to some aspects, user interface 110 comprises software stored in a memory unit of image generation apparatus 105 (such as the memory unit 2510 described with reference to FIG. 25).

Image generation model 115 is an example of, or includes aspects of, the corresponding element described with reference to FIGS. 9-13, 18, 19, and 25. According to some aspects, image generation model 115 comprises machine learning parameters stored in the memory unit of image generation apparatus 105. According to some aspects, image generation model 115 comprises an artificial neural network (ANN) that is trained as described with reference to FIGS. 16-23 to generate a synthetic image (e.g., a diffusion model).

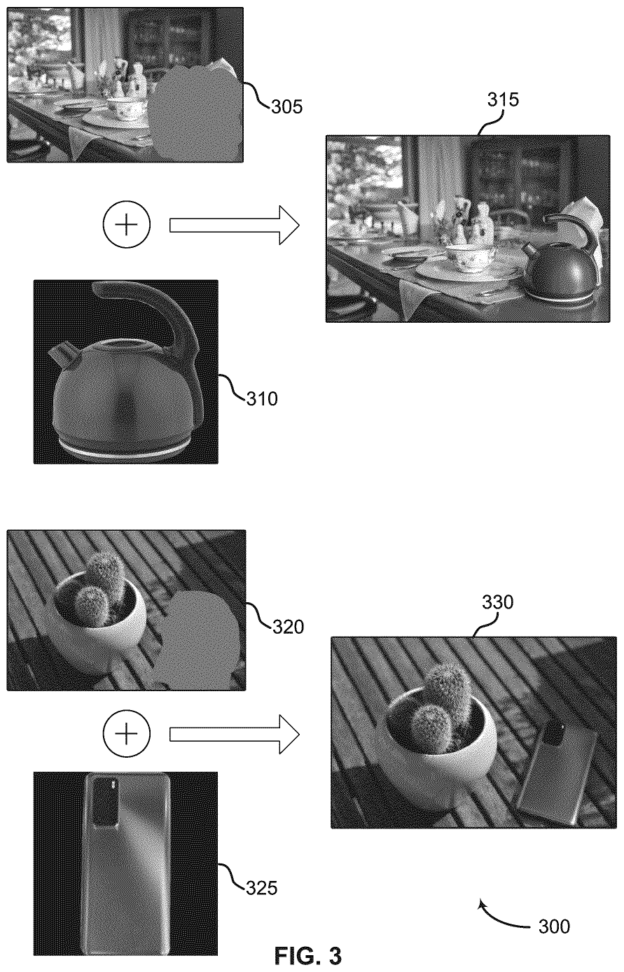

Further detail regarding the architecture of an image generation system is provided with reference to FIGS. 3-13 and 24-25. Further detail regarding a processes for generating a synthetic image is provided with reference to FIGS. 2 and 14-15. Further detail regarding a process for training image generation model 115 is provided with reference to FIGS. 16-23.

Cloud 120 is a computer network configured to provide on-demand availability of computer system resources, such as data storage and computing power. In some examples, cloud 120 provides resources without active management by a user. The term “cloud” is sometimes used to describe data centers available to many users over the Internet. Some large cloud networks have functions distributed over multiple locations from central servers. A server is designated an edge server if the server has a direct or close connection to a user. In some examples, cloud 120 is limited to a single organization or be available to many organizations. In one example, cloud 120 includes a multi-layer communications network comprising multiple edge routers and core routers. In another example, cloud 120 is based on a local collection of switches in a single physical location. According to some aspects, cloud 120 provides communications between image generation apparatus 105, database 125, and the user device.

Database 125 is an organized collection of data. In an example, database 125 stores data in a specified format known as a schema. According to some aspects, database 125 is structured as a single database, a distributed database, multiple distributed databases, or an emergency backup database. Data storage and processing in database 125 is manageable by a database controller, which can be operated by a user or automatically without interaction from the user. According to some aspects, database 125 is included in image generation apparatus 105. According to some aspects, database 125 is external to image generation apparatus 105 and communicates with image generation apparatus 105 via cloud 120.

According to some aspects, user device 130 is a personal computer, laptop computer, mainframe computer, palmtop computer, personal assistant, mobile device, or any other suitable processing apparatus. In some examples, user device 130 includes software that displays user interface 110 provided by image generation apparatus 105.

According to some aspects, a user device user interface enables a user to interact with user device 130. In some embodiments, the user device user interface includes an audio device, such as an external speaker system, an external display device such as a display screen, or an input device (e.g., a remote-control device interfaced with the user interface directly or through an I/O controller module). In some cases, the user device user interface is a graphical user interface.

Masked input image 140 is an example of, or includes aspects of, the corresponding element described with reference to FIGS. 10, 19, and 22. Reference image 145 is an example of, or includes aspects of, the corresponding element described with reference to FIGS. 9, 10, 18, 19, and 22. Synthetic image 150 is an example of, or includes aspects of, the corresponding element described with reference to FIGS. 9, 10, 18, and 19.

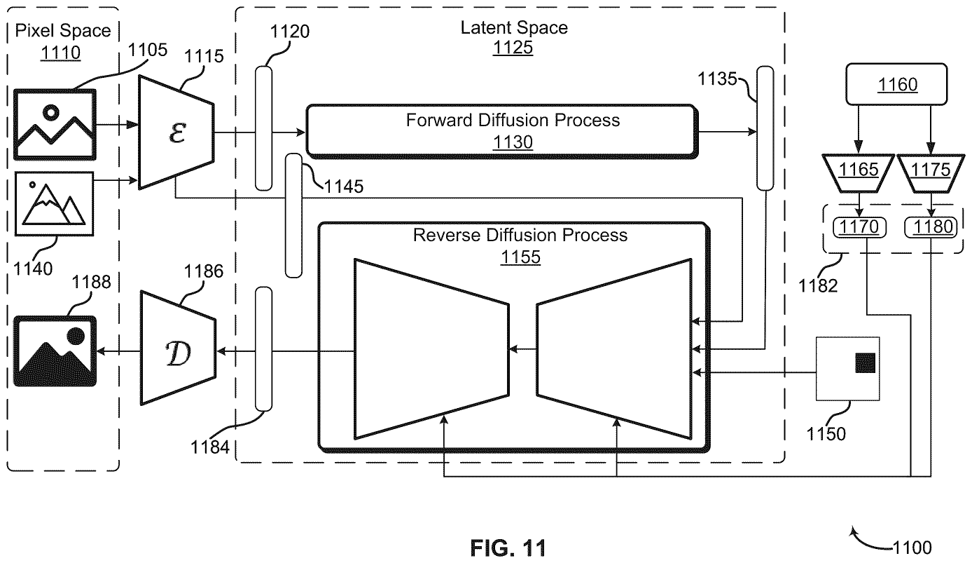

FIG. 2 shows an example of a method 200 for generating a synthetic image according to aspects of the present disclosure. In some examples, method 200 describes an operation of the image generation model 2515 described with reference to FIG. 25 such as an application of the guided latent diffusion model 1100 described with reference to FIG. 11. In some examples, these operations are performed by a system including a processor executing a set of codes to control functional elements of an apparatus such as the image generation model described in FIG. 11.

Additionally or alternatively, steps of the method 200 may be performed using special-purpose hardware. Generally, these operations are performed according to the methods and processes described in accordance with aspects of the present disclosure. In some cases, the operations described herein are composed of various substeps or are performed in conjunction with other operations.

At operation 205, the system provides a reference image depicting an object, an input image, and a mask. In some cases, the operations of this step may be performed by a user as described with reference to FIG. 1. In an example, the user provides the reference image, the input image, and the mask (either independently of the input image or within the input image as a masked input image) to an image generation system via a user interface displayed on a user device by the image generation system as described with reference to FIG. 1. In some embodiments, the user provides an area selection input to an input image displayed on the user interface, and the image generation system generates the mask based on the area selection input.

At operation 210, the system encodes the reference image using a harmonization encoder and an identity encoder. In some cases, the operations of this step refer to, or may be performed by, an image generation apparatus as described with reference to FIGS. 24 and 25. In an example, the image generation apparatus encodes the reference image as described with reference to FIG. 9 or 10.

At operation 215, the system generates a synthetic image using the encoded reference image and the input image, including the object at a location dictated by the mask. In some cases, the operations of this step refer to, or may be performed by, an image generation apparatus as described with reference to FIGS. 24 and 25. In an example, the image generation apparatus generates the synthetic image as described with reference to FIG. 9 or 10.

In some embodiments, an image generation model of the image generation apparatus initializes a noise map that includes random noise. The noise map may be in a pixel space or a latent space. By initializing an image with random noise, different variations of an image including the content described by the conditional guidance can be generated. The image generation model generates the synthetic image based on a combination of the noise map, the input image, and the mask, using the embeddings of the reference image as conditional guidance vector(s). For example, the synthetic image may be generated using a reverse diffusion process as described with reference to FIGS. 9-11.

FIG. 3 shows an example 300 of synthetic images according to aspects of the present disclosure. The example shown includes first input image 305, first reference image 310, first synthetic image 315, second input image 320, second reference image 325, and second synthetic image 330.

Referring to FIG. 3, first input image 305 and second input image 320 are examples of either complete (e.g., unmasked) input images as described with reference to FIG. 9, with masked regions included as a visual representation of a separate input image mask, or masked input images as described with reference to FIG. 10. First synthetic image 315 is generated based on first input image 305 and first reference image 310 as described with reference to FIG. 9 or 10, and second synthetic image 330 is generated based on second input image 320 and second reference image 325 as described with reference to FIG. 9 or 10.

First synthetic image 315 depicts a composition of a kettle from first reference image 310 in a dining room scene from first input image 305. While the shape, size, lighting, pose, color, and shadow of the kettle are altered to accurately match the dining room scene, the visual identity of the kettle is maintained. Similarly, second synthetic image 330 depicts a composition of a phone from second reference image 325 in a table scene from second input image 320. While the shape, size, lighting, pose, color, and shadow of the phone are altered to accurately match the table scene, the visual identity of the phone is maintained.

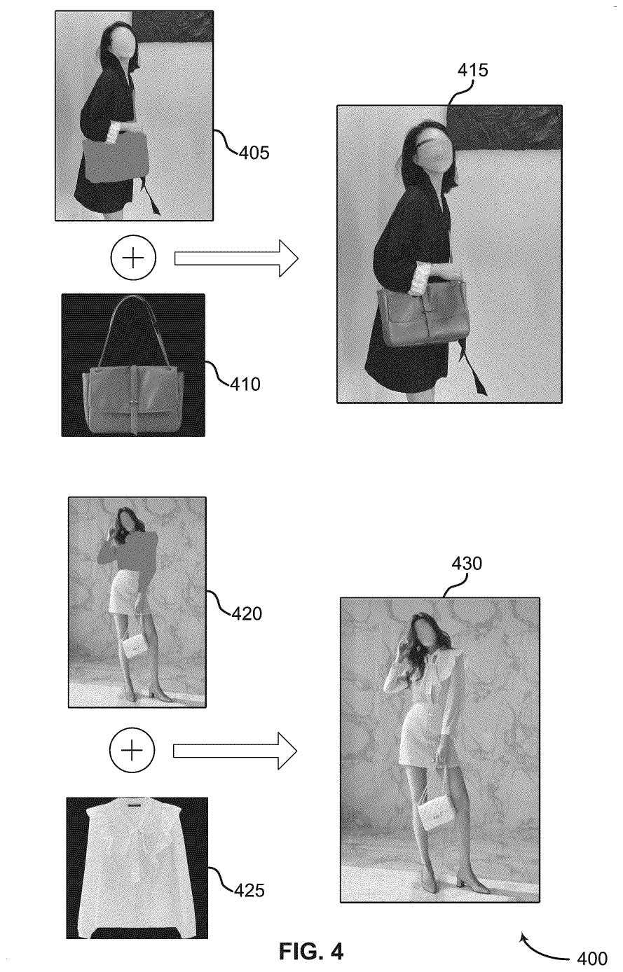

FIG. 4 shows an example 400 of synthetic images depicting a virtual-try on according to aspects of the present disclosure. The example shown includes first masked input image 405, first reference image 410, first synthetic image 415, second masked input image 420, second reference image 425, and second synthetic image 430.

Referring to FIG. 4, first synthetic image 415 is generated based on first masked input image 405 and first reference image 410 as described with reference to FIG. 10, and second synthetic image 430 is generated based on second masked input image 420 and second reference image 425 as described with reference to FIG. 10. FIG. 4 illustrates the application of the image generation process performed by the image generation model as described with reference to FIG. 10 for performing virtual try-ons of clothes and accessories, using irregularly shaped masks. The faces depicted in FIG. 4 are intentionally blurred and do not represent a result of the image generation process.

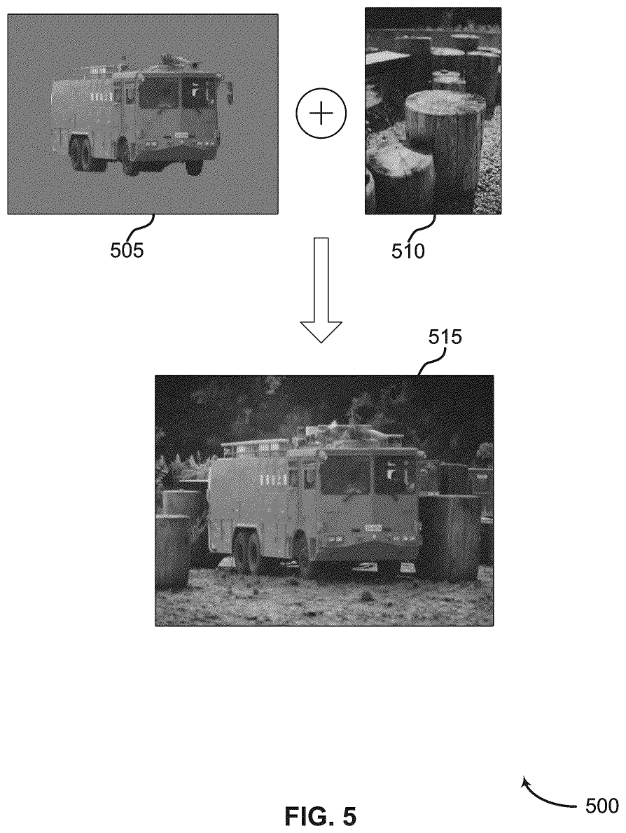

FIG. 5 shows an example 500 of a synthetic image depicting a background replacement according to aspects of the present disclosure. The example shown includes masked input image 505, reference image 510, and synthetic image 515. Referring to FIG. 5, aspects of the present disclosure may be used to replace a background of an input image. For example, masked input image 505 depicts a scene including a truck, and a background that is masked out, while reference image 510 depicts a set of objects including a rocky ground, wooden posts, and plants. Synthetic image 515 is generated to depict the set of objects from reference image 510 with the scene from masked input image 505.

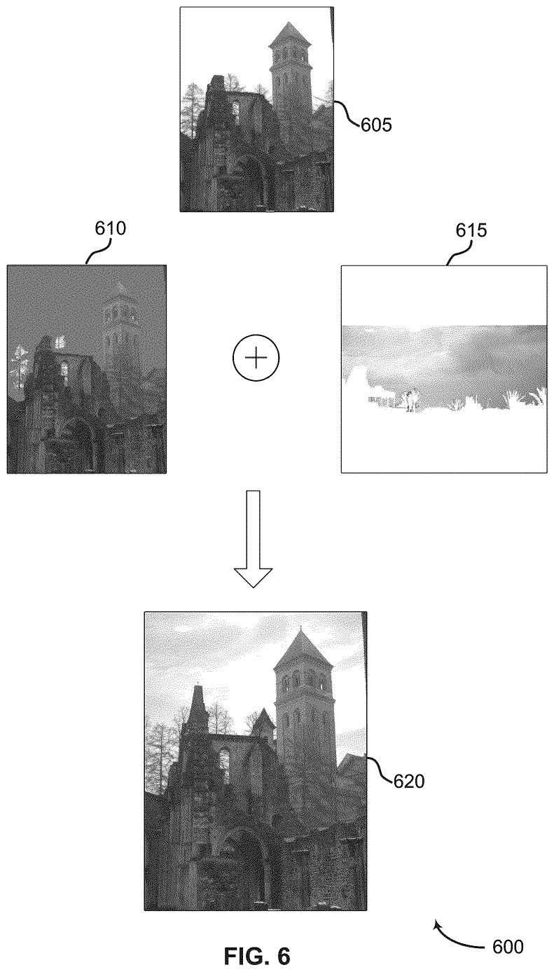

FIG. 6 shows an example 600 of a synthetic image depicting an environmental object replacement according to aspects of the present disclosure. The example shown includes original image 605, masked input image 610, reference image 615, and synthetic image 620. Referring to FIG. 6, aspects of the present disclosure may be used to replace an environmental object of an image, such as a sky. For example, original image 605 depicts a building and a gray sky. Masked input image 610 depicts the scene from original image 605 with a mask corresponding to the sky. Reference image 615 depicts a cloudy sky object. Synthetic image 620 is generated to depict the cloudy sky object from reference image 615 with the scene from masked input image 610.

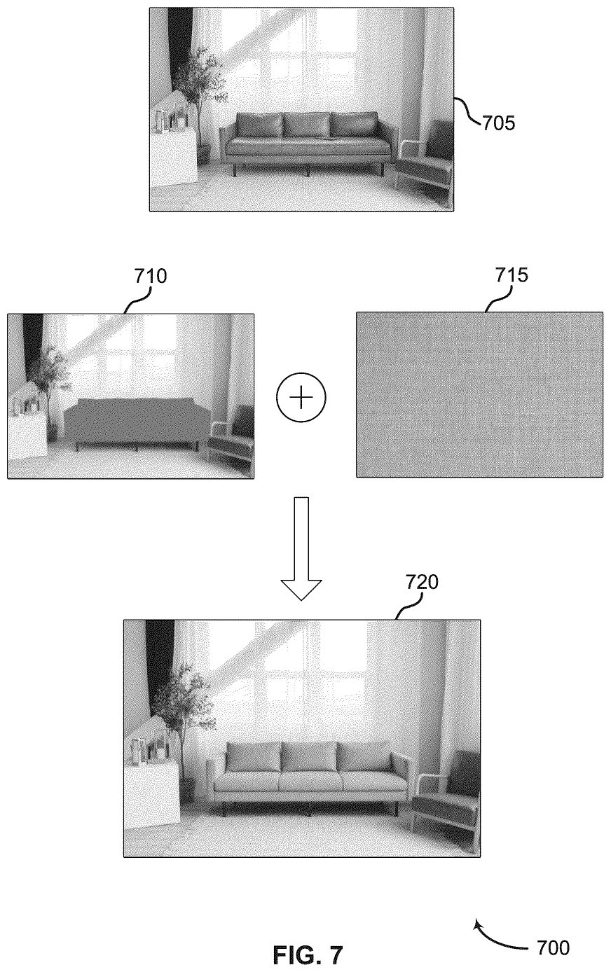

FIG. 7 shows an example 700 of a synthetic image depicting a texture replacement according to aspects of the present disclosure. The example shown includes original image 705, masked input image 710, reference image 715, and synthetic image 720. Referring to FIG. 7, aspects of the present disclosure may be used to replace a texture in a scene of an input image. For example, original image 705 depicts a scene including a leather couch, masked input image 710 depicts the scene from original image 705 with a mask corresponding to the couch, and reference image 715 depicts a fabric texture object. Synthetic image 720 is generated to depict the scene from masked input image 710 with the fabric texture object from reference image 715. In some embodiments, synthetic image 720 is generated based on a combination of original image 705 and masked input image 710 being provided as input to an image generation model, such as the image generation model 2515 described with reference to FIG. 25, such that the structure of the object in original image 705 (e.g., both the perimeter shape of the couch and the internal shape of the couch, such as the shape of the cushions and arms) corresponding to the masked area of masked input image 710 is maintained, while the texture of the couch is replaced according to the object depicted in reference image 715.

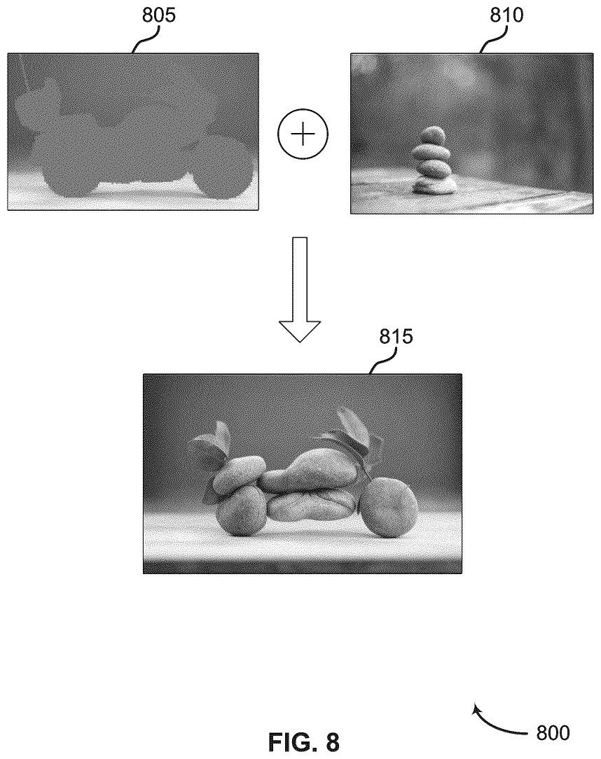

FIG. 8 shows an example 800 of a synthetic image depicting a creative generated object according to aspects of the present disclosure. The example shown includes masked input image 805, reference image 810, and synthetic image 815. Referring to FIG. 8, aspects of the present disclosure may be used for creative object generation. For example, masked input image 805 depicts a scene and a mask suggesting the shape of a motorcycle, and reference image 810 depicts a stack of rocks on a wooden table. Synthetic image 815 is generated to depict a creative object including the rock objects from the reference image in the shape of a motorcycle in the scene from masked input image 805.

FIG. 9 shows an example of an image generation model 900 for generating a synthetic image based on a scene input image according to aspects of the present disclosure. The example shown includes image generation model 900, noise 920, scene input image 925, input image mask 930, reference image 935, harmonization embedding 940, identity embedding 945, and synthetic image 950. In one aspect, image generation model 900 includes harmonization encoder 905, identity encoder 910, and reverse diffusion process 915.

Referring to FIG. 9, reverse diffusion process 915 of image generation model 900 receives noise (e.g., noise 920), a scene input image (e.g., scene input image 925), and an input image mask (e.g., input image mask 930) as input. The noise comprises Gaussian noise generated using a forward diffusion process described with reference to FIGS. 11 and 16.

In some embodiments, an image generation apparatus (such as the image generation apparatus 105 described with reference to FIG. 1) generates the input image mask in response to a user input. In an example, a user provides the scene input image to the image generation apparatus via a user interface, and the user interface displays the scene input image. The user provides the user input (e.g., an area selection input such as a rectangular drag-and-drop area selection input or a free-form area selection input, a brush stroke input, etc.) to the scene input image displayed in the user interface to select a region of the scene input image for including an object. The image generation apparatus generates the input image mask including masked pixels corresponding to the user input.

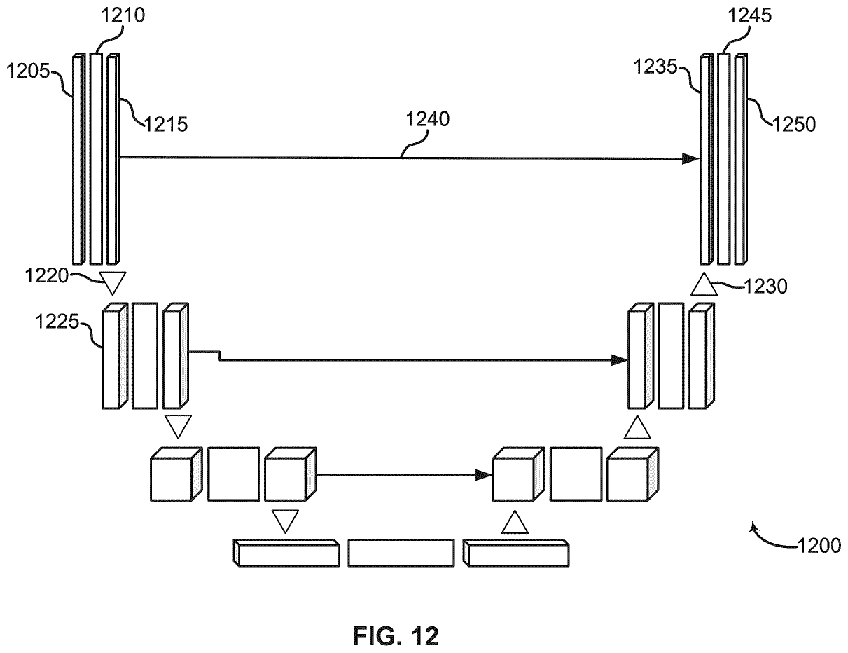

In some embodiments, the noise, the scene input image, and the input image mask are concatenated. In an example, reverse diffusion process 915 comprises the U-Net 1200 described with reference to FIG. 12, and the noise, the scene input image, and the input image are concatenated in a channel dimension of the U-Net. In some embodiments, where reverse diffusion process 915 comprises a pixel diffusion process, the noise and the scene input image comprise an equal number of channels (e.g., three channels) and the mask comprises one channel, and the concatenated input therefore comprises a sum of the channels (e.g., seven). In some embodiments, where reverse diffusion process 915 comprises a latent diffusion process, an encoder of a variational autoencoder (VAE) (such as the image encoder 1115 described with reference to FIG. 11) encodes the scene input image to obtain an image embedding (a multi-channel (e.g., 12-channel) latent feature) in a latent space, and the noise comprises a noisy latent feature having a same number of channels (e.g., 12) as the image embedding. Image generation model 900 then concatenates the image embedding, the noise, and the (single-channel) mask to obtain the concatenated input (e.g., a 25-channel input).

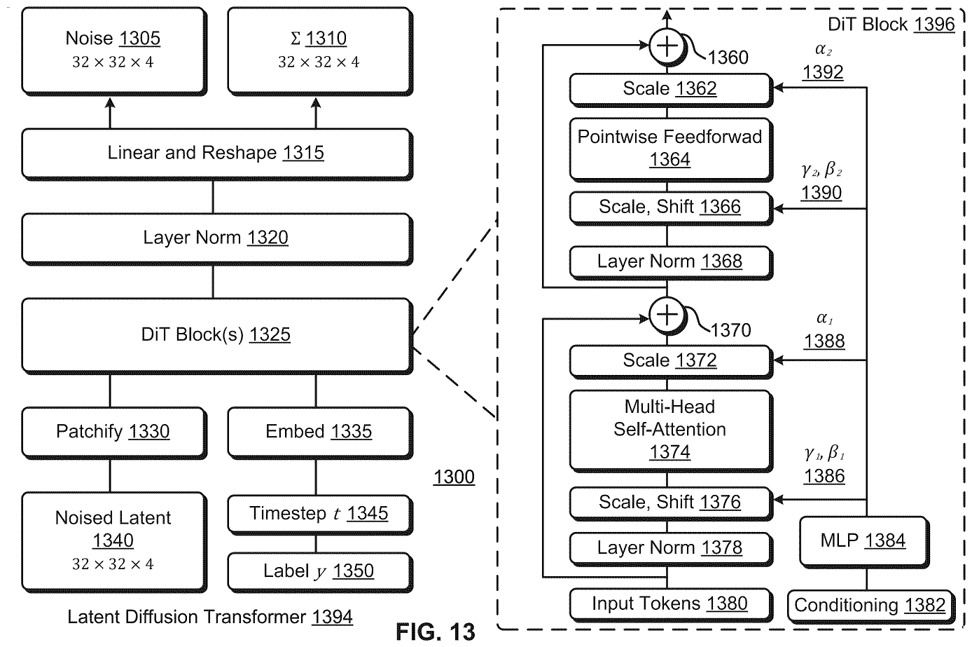

In another example, reverse diffusion process 915 comprises a diffusion transformer described with reference to FIG. 13 and the noise comprises a noise latent. The encoder encodes the scene input image to obtain an image embedding and encodes the mask to obtain a mask embedding. The noise latent, the image embedding, and the mask embedding are patchified to obtain latent patches, the latent patches are concatenated as a one-dimensional tensor, and the one-dimensional tensor is provided as input to diffusion transformer blocks of the diffusion transformer.

Meanwhile, harmonization encoder 905 encodes a reference image (e.g., reference image 935) depicting an object to obtain a harmonization embedding (e.g., harmonization embedding 940) representing semantic information of the object in a guidance space. In some embodiments, identity encoder 910 encodes the reference image to obtain an identity embedding (e.g., identity embedding 945) representing an identity of the object in the guidance space.

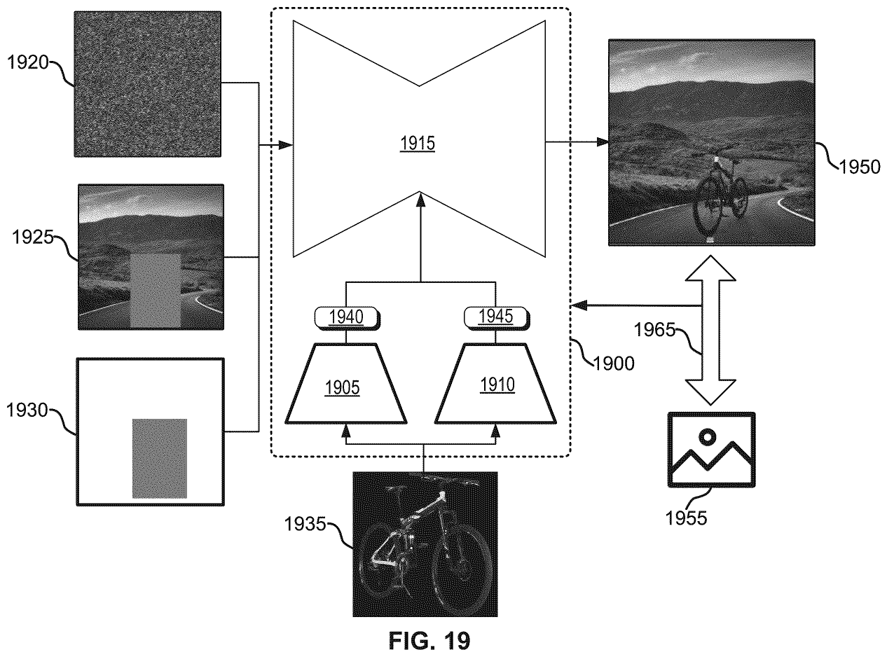

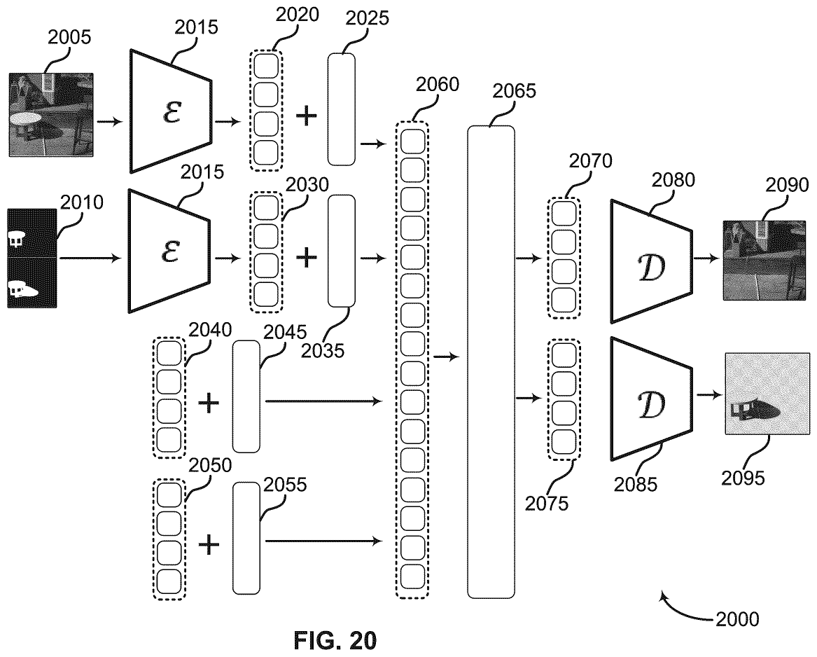

Image generation model 900 performs reverse diffusion process 915 on the concatenated input as described with reference to FIGS. 11 and 16. Reverse diffusion process 915 incorporates the harmonization embedding (and in some cases the identity embedding) via a cross-attention mechanism to provide guidance for reverse diffusion process 915 to composite the object with the scene input image. During reverse diffusion process 915, pixels that do not correspond to the object are replaced with original pixels (or latents) from the scene input image at each denoising step, thereby including original content from the scene input image in pixels corresponding to the input image mask. In some embodiments, the diffusion transformer omits a cross-attention mechanism, and the harmonization embedding (or the harmonization embedding and the identity embedding) are concatenated with the one-dimensional tensor. In some embodiments, the encoder of the VAE encodes the reference image to obtain a reference image embedding, and the reference image embedding is concatenated with the one-dimensional tensor. In some embodiments, the diffusion transformer is trained as described with reference to FIG. 19 or 20 using the concatenation of the one-dimensional tensor and the reference image embedding as input to the diffusion transformer.

Where reverse diffusion process 915 is a pixel diffusion process, reverse diffusion process 915 outputs a synthetic image (e.g., synthetic image 950). Where reverse diffusion process 915 is a latent diffusion process, reverse diffusion process 915 outputs image features in the latent space, and a decoder of the VAE (e.g., the decoder 1186 described with reference to FIG. 11) decodes the image features into a pixel space to obtain the synthetic image. As shown in FIG. 9, synthetic image 950 depicts the bike from reference image 935 composited onto the road depicted in scene input image 925, such that the bike is relighted, recolored, repositioned, and shadowed to match the road. Furthermore, because scene input image 925 was provided as an input, only pixels of synthetic image 950 depicting the bike differ from scene input image 925. For example, the road stripe in the center of the road beneath the bike is retained. This is helpful for insertion use cases if a user desires to keep an original background when inserting their own object.

Image generation model 900 is an example of, or includes aspects of, the corresponding elements described with reference to FIGS. 1, 10-13, 18-19, and 25. Harmonization encoder 905 and identity encoder 910 are examples of, or include aspects of, the corresponding elements described with reference to FIGS. 10-11 and 18-19. Reverse diffusion process 915 is an example of, or includes aspects of, the corresponding element described with reference to FIGS. 10-13, 15, and 18-19.

In some aspects, harmonization encoder 905 includes an image encoder trained together with a text encoder using a dataset comprising pairs of images and text describing the images, using a loss function generated based on an output of both the image encoder and the text encoder. In an example, harmonization encoder 905 comprises a Contrastive Language-Image Pretraining (CLIP) image encoder. CLIP is a neural network model designed to learn visual concepts from natural language supervision. CLIP aligns images and text descriptions in a shared embedding space using contrastive learning. In some embodiments, harmonization encoder 905 comprises a convolutional neural network (CNN). In some embodiments, harmonization encoder 905 comprises a vision transformer (ViT).

A ViT is a deep learning model that applies principles of a transformer to image recognition tasks by processing an image input as a sequence. In an example, a ViT splits an image into small, fixed-size patches. Each of the patches is then processed into a vector and linearly embedded into a higher-dimensional space. The embeddings are combined with positional information that helps the model understand the layout of the patches in the original image and are then fed into a standard transformer encoder.

Inside the transformer, self-attention mechanisms allow the model ViT to learn complex relationships between all patches, regardless of their physical proximity, enabling the ViT to capture both local and global features in an image without relying on convolutions. After several layers of attention and transformation, the ViT aggregates the learned features to make a final prediction.

According to some aspects, identity encoder 910 comprises an ViT that is trained using a dataset comprising unlabeled images. In an example, identity encoder 910 comprises a DinoV2 model. According to some aspects, identity encoder 910 comprises a distillation of a larger ViT model. According to some aspects, identity encoder 910 is trained using relatively high-resolution images during a period of the training. According to some aspects, identity encoder 910 is trained using a self-supervised learning, where the self-supervised learning includes a two-step process of pretraining and fine-tuning, where the identity encoder 910 learns representations from unlabeled data through auxiliary tasks and adapts to specific tasks using smaller amounts of labeled data. According to some aspects, the identity encoder 910 is trained to preserve identity information of an object depicted in an image input into identity encoder 910.

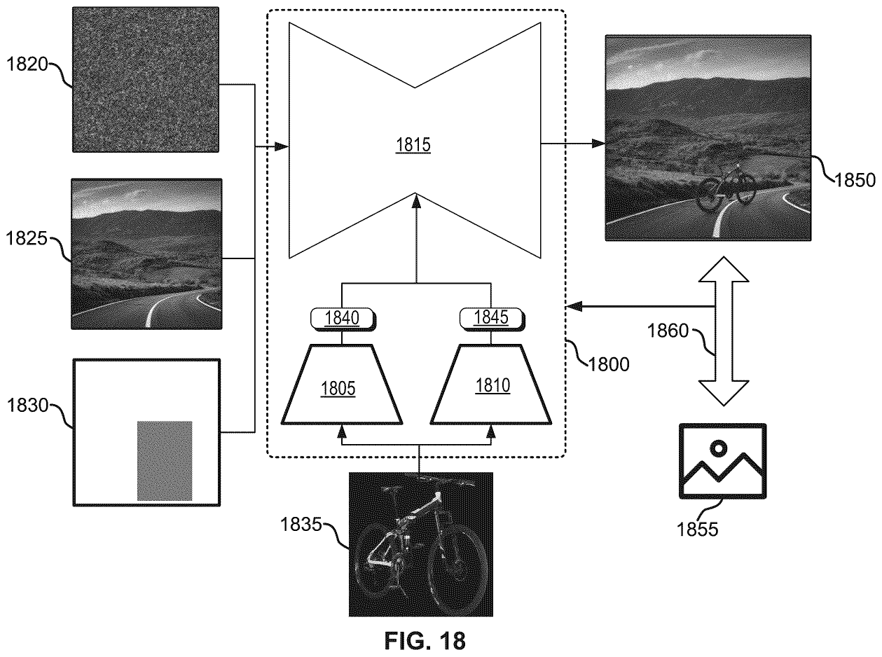

Noise 920, input image mask 930, harmonization embedding 940, and identity embedding 945 are examples of, or include aspects of, the corresponding elements described with reference to FIGS. 10 and 18-19. Scene input image 925 is an example of, or includes aspects of, the corresponding element described with reference to FIG. 18. Reference image 935 is an example of, or includes aspects of, the corresponding element described with reference to FIGS. 1, 10, 18-19, and 22. Synthetic image 950 is an example of, or includes aspects of, the corresponding element described with reference to FIGS. 1, 10, and 18-19.

FIG. 10 shows an example of an image generation model 1000 for generating a synthetic image based on a masked input image according to aspects of the present disclosure. The example shown includes image generation model 1000, noise 1020, masked input image 1025, input image mask 1030, reference image 1035, harmonization embedding 1040, identity embedding 1045, and synthetic image 1050. In one aspect, image generation model 1000 includes harmonization encoder 1005, identity encoder 1010, and reverse diffusion process 1015.

FIG. 10 illustrates a similar image generation model as the image generation model 900 described with reference to FIG. 9, and redundant descriptions thereof are omitted. In contrast to the reverse diffusion process 915, which receives a scene input image as input, reverse diffusion process 1015 receives a masked input image (e.g., masked input image 1025) as input. The masked input image input causes reverse diffusion process 1015 to generate a new pixel for every pixel included within the masked area defined by a masked region in the masked input image, and therefore a synthetic image generated by reverse diffusion process 1015 (e.g., synthetic image 1050) depicts new background content in addition to a composited object. For example, synthetic image 1050 depicts a new road surface in an area corresponding to masked region, as can be seen by the presence of a center road stripe in masked input image 1025 and an omission of the center road stripe in synthetic image 1050. This is helpful for replacement use cases in which a user wishes to remove an existing object depicted in the input image, such as the virtual try-on examples shown with reference to FIG. 4.

In some embodiments, an image generation apparatus (such as the image generation apparatus 105 described with reference to FIG. 1) generates the input image mask and the masked input image in response to a user input. In an example, a user provides a scene input image to the image generation apparatus via a user interface, and the user interface displays the scene input image. The user provides the user input (e.g., a rectangular drag-and-drop input) to the scene input image displayed in the user interface to select a region of the scene input image for including an object. The image generation apparatus generates the input image mask including masked pixels corresponding to the user input and adds a corresponding masked region to the scene input image to obtain the masked input image. In some embodiments, the image generation apparatus generates the masked input image in response to an additional user input provided to the user interface (e.g., a selection of an option to include synthetic background content in the synthetic image).

Image generation model 1000 is an example of, or includes aspects of, the corresponding element described with reference to FIGS. 1, 9, 11-13, 18-19, and 25. Harmonization encoder 1005 and identity encoder 1010 are examples of, or include aspects of, the corresponding elements described with reference to FIGS. 9, 11, and 18-19. Reverse diffusion process 1015 is an example of, or includes aspects of, the corresponding element described with reference to FIGS. 9, 11-13, 15, and 18-19.

Noise 1020, input image mask 1030, harmonization embedding 1040, and identity embedding 1045 are examples of, or include aspects of, the corresponding elements described with reference to FIGS. 9 and 18-19. Masked input image 1025 is an example of, or includes aspects of, the corresponding element described with reference to FIGS. 1, 19, and 22. Reference image 1035 is an example of, or includes aspects of, the corresponding element described with reference to FIGS. 1, 9, 18-19, and 22. Synthetic image 1050 is an example of, or includes aspects of, the corresponding element described with reference to FIGS. 1, 9, and 18-19.

FIG. 11 shows an example of a guided latent diffusion model 1100 according to aspects of the present disclosure. In some examples, guided latent diffusion model 1100 describes the operation and architecture of the image generation model 2515 described with reference to FIG. 25.

Diffusion models are a class of generative neural networks which can be trained to generate new data with features similar to features found in training data. In particular, diffusion models can be used to generate novel images. Diffusion models can be used for various image generation tasks including image super-resolution, generation of images with perceptual metrics, conditional generation (e.g., generation based on text guidance), image inpainting, and image manipulation.

Diffusion models work by iteratively adding noise to the data during a forward process and then learning to recover the data by denoising the data during a reverse process. For example, image encoder 1115 encodes original image 1105 from pixel space 1110 and generates original image features 1120 in latent space 1125.

Guided latent diffusion model 1100 applies forward diffusion process 1130 to gradually add noise to the original image features 1120 to obtain noisy features 1135 (e.g., the noise 920 and 1020 described with reference to FIGS. 9 and 10, respectively) at various noise levels. Meanwhile, image encoder 1115 encodes an input image 1140 (e.g., the input image described with reference to FIG. 9 or 10) to obtain an input image embedding 1145 in latent space 1125. Noisy features 1135 are concatenated with input image embedding 1145 and an input image mask 1150 provided in pixel space 1110 (e.g., the mask described with reference to FIG. 9 or 10) as described with reference to FIG. 9 or 10 to obtain concatenated features. Next, a reverse diffusion process 1155 (e.g., the U-Net 1200 as described with reference to FIG. 12 or the diffusion transformer architecture 1300 as described with reference to FIG. 13) gradually removes the noise from the concatenated features at the various noise levels to obtain denoised image features 1184. Then, decoder 1186 decodes the denoised image features 1184 from the latent space 1125 to the pixel space 1110 to obtain an output image 1188 (e.g., a synthetic image as described with reference to FIGS. 1, 3-8, 9-10, and 18-19). In some cases, an output image 1188 is created from each of the various noise levels.

According to some aspects, image encoder 1115 and decoder 1186 comprise a variational autoencoder (VAE). A VAE is an artificial neural network (ANN) that learns to map an image from a pixel space to a latent space and to map the encoded image from the latent space to the pixel space. In some cases, a VAE comprises an encoder network that maps an input image to a lower-dimensional latent space and a decoder network that generates a new image from the latent space representation. A VAE can generate different images by sampling different points in the latent space.

The reverse diffusion process 1155 is guided based on a reference image 1160 (e.g., the reference image described with reference to FIG. 9 or 10). The reference image 1160 is encoded using harmonization encoder 1165 (e.g., the harmonization encoder 905 and 1005 respectively described with reference to FIGS. 9 and 10) and identity encoder 1175 (e.g., the identity encoder 910 and 1010 respectively described with reference to FIGS. 9 and 10) to obtain a harmonization embedding 1170 (e.g., the harmonization embedding 940 and 1040 respectively described with reference to FIGS. 9 and 10) and an identity embedding 1180 (e.g., the identity embedding 945 and 1045 respectively described with reference to FIGS. 9 and 10), respectively, in guidance space 1182. The harmonization embedding 1170 and the identity embedding 1180 are combined with the concatenated features at one or more layers of the reverse diffusion process 1155 to ensure that the output image 1188 includes content depicted in the reference image 1160. For example, the harmonization embedding 1170 and the identity embedding 1180 can be combined with the concatenated features using a cross-attention block within the reverse diffusion process 1155.

In the machine learning field, an attention mechanism is a method of placing differing levels of importance on different elements of an input. Calculating attention may involve three basic steps. First, a similarity between query and key vectors obtained from the input is computed to generate attention weights. Similarity functions used for this process can include dot product, splice, detector, and the like. Next, a softmax function is used to normalize the attention weights. Finally, the attention weights are weighed together with their corresponding values.

Methods of operating diffusion models include a Denoising Diffusion Probabilistic Model (DDPM) and a Denoising Diffusion Implicit Models (DDIM). In DDPM, the generative process includes reversing a stochastic Markov diffusion process. DDIMs, on the other hand, use a deterministic process so that the same input results in the same output. In some cases, DDIM can reduce the number of timesteps during image generation. Diffusion models may also be characterized by whether the noise is added to the image itself, or to image features generated by an encoder (i.e., latent diffusion). In a pixel diffusion model, noise is added and removed in pixel space. In a latent diffusion model, the noise is added (and removed) in a latent space of image features rather than in pixel space. Thus, a latent diffusion model generates image features using reverse diffusion, and these image features can be decoded to obtain a synthetic image.

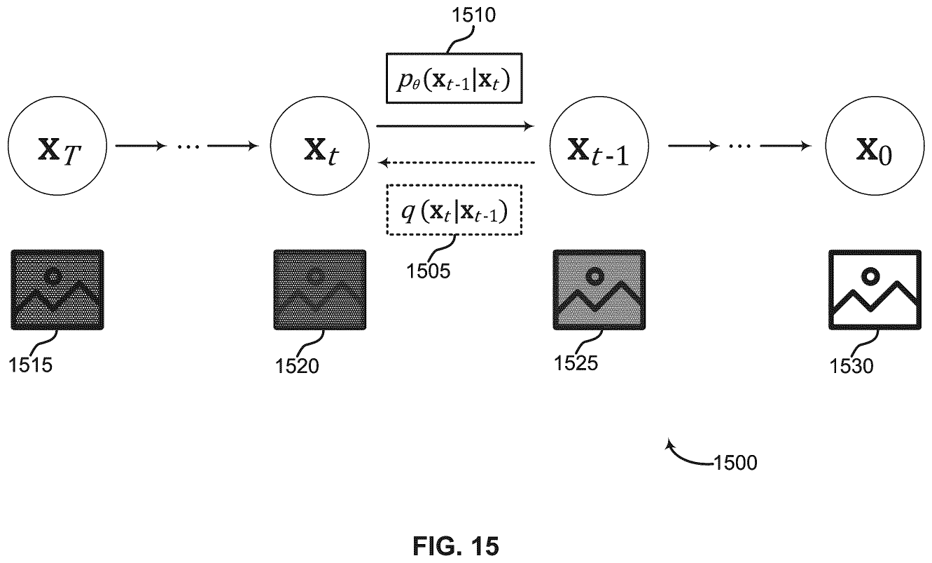

FIG. 12 shows an example of a U-Net according to aspects of the present disclosure. In some examples, U-Net 1200 is an example of the component that performs the reverse diffusion process described with reference to FIGS. 9-11 and includes architectural elements of the image generation model 2515 described with reference to FIG. 25. The U-Net 1200 depicted in FIG. 12 is an example of, or includes aspects of, the architecture used within the reverse diffusion process described with reference to FIGS. 11 and 15.

In some examples, diffusion models are based on a neural network architecture known as a U-Net. The U-Net 1200 takes input features 1205 having an initial resolution and an initial number of channels and processes the input features 1205 using an initial neural network layer 1210 (e.g., a convolutional network layer) to produce intermediate features 1215. The intermediate features 1215 are then down-sampled using a down-sampling layer 1220 such that down-sampled features 1225 features have a resolution less than the initial resolution and a number of channels greater than the initial number of channels.

This process is repeated multiple times, and then the process is reversed. That is, the down-sampled features 1225 are up-sampled using up-sampling process 1230 to obtain up-sampled features 1235. The up-sampled features 1235 can be combined with intermediate features 1215 having a same resolution and number of channels via a skip connection 1240. These inputs are processed using a final neural network layer 1245 to produce output features 1250. In some cases, the output features 1250 have the same resolution as the initial resolution and the same number of channels as the initial number of channels.

In some cases, U-Net 1200 takes additional input features to produce conditionally generated output. For example, the additional input features could include a vector representation of an input prompt. The additional input features can be combined with the intermediate features 1215 within the neural network at one or more layers. For example, a cross-attention module can be used to combine the additional input features and the intermediate features 1215.

FIG. 13 shows an example of a diffusion transformer (DiT) architecture 1300 according to aspects of the present disclosure. In some examples, DiT architecture 1300 is an example of the component that performs the reverse diffusion process described with reference to FIGS. 9-11 and includes architectural elements of the image generation model 2515 described with reference to FIG. 25. The DiT architecture 1300 depicted in FIG. 13 is an example of, or includes aspects of, the architecture used within the reverse diffusion process described with reference to FIGS. 11 and 15.

The example shown includes predicted noise 1305, predicted covariance 1310, linear and reshape layers 1315, normalization layer 1320, DiT block(s) 1325, patchify operation 1330, embedding 1335, noised latent 1340, timestep information 1345, label information 1350, and an implementation of one block in the DiT blocks 1325 by a DiT block 1396.

The DiT block 1396 includes second residual connection 1360, second scaling operations 1362, feed-forward network 1364, post-normalization second scaling and shifting 1366, second normalization 1368, first residual connection 1370, first scaling operations 1372, self-attention 1374, post-normalization first scaling and shifting 1376, first normalization 1378, input tokens 1380, conditioning tokens 1382, multi-layer perceptron (MLP) 1384, post-normalization first scaling and shifting parameters 1386, first scaling parameter 1388, post-normalization second scaling and shifting parameters 1390, and second scaling parameter 1392. In some embodiments, the architecture employes a latent diffusion transformer 1394. In some embodiments, DiT block 1396 employs an “adaLN-Zero” technique.

A diffusion transformer (DiT) is a popular architecture for diffusion models and is designed to be structurally faithful to standard transformer architecture. DiT incorporates transformer structures' scaling properties. For training denoising diffusion probabilistic models (DDPMs) of images (e.g., spatial representations of images), DiT is based on a vision transformer (ViT) architecture which operates on sequences of patches. DiT processes images by dividing them into patches, converting these patches into tokens, and applying attention mechanisms to model relationships between different regions of the image. This approach allows the model to capture both local and long-range dependencies in the image generation process.

In some cases, input to DiT is a spatial representation z. For 256×256×3 images, z has shape 32×32×4. A first layer of a DiT is to carry out patchify operation, where the DiT divides an input image into patches and converts the patches (a form of spatial input) into a sequence of T tokens, each of dimension d, by linearly embedding each patch in the input. Following the patchify process, ViT frequency-based positional embeddings are applied to all input tokens. In some cases, the number of tokens T created by patchify is determined by a patch size hyperparameter p. In some cases, T=(I/p)², where/is another shape parameter. Thus, halving p will quadruple T, which in some cases at least quadruples a total of transformer giga floating point operations (Gflops). In some examples, changing p has no impact on downstream parameter counts. I.e., parameter counts in downstream layers of DiT may be independent from p. In some examples, p=2, 4 or 8. Various patch sizes, transformer block architectures, and model sizes are implemented.

Following the patchify operation, attention mechanisms are applied to model relationships between different regions of the image in one or more DiT blocks. In addition to noised image inputs, diffusion models sometimes process additional conditional information such as noise timesteps t, class labels c, natural language information, etc. Four variants of transformer blocks for processing conditional inputs including both input information and conditional information are described below.

In some cases, DiT blocks in the DiT network are implemented using adaptive layer norm (adaLN) blocks. Following adaptive normalization layers in generative adversarial networks (GANs) and conventional diffusion models with U-Net backbones, in some examples, standard normalization layers in transformer blocks are replaced with adaptive layer norm (adaLN). Rather than directly learning dimension-wise scale γ and shift parameters β, in adaLN, the system regresses γ and β from a sum of the embedding vectors of the noise timesteps t and the class labels c. An adaLN adds relatively small numbers of Gflops and is more efficient. Additionally, adaLN is a conditioning mechanism that applies a same function to all tokens.

In some cases, DiT blocks in the DiT network are implemented using adaLN-Zero blocks that leverage zero-initialization techniques. In Residual Networks (ResNets), initializing each residual block as the identity function x [symbol] x is beneficial. In some examples, zero-initializing a final batch norm scale factor in each block accelerates large-scale training in supervised learning settings. Diffusion models based on U-Nets use a similar initialization strategy, zero-initializing a final convolutional layer in each block prior to residual connections.

An adaLN-Zero block is modified from an adaLN block using similar zero-initialization techniques. In addition to regressing the dimension-wise scale γ and the shifting parameters β, the system also regresses dimension-wise scaling parameters αs that are applied immediately prior to residual connections within the DiT block. The network initializes a multi-layer perceptron (MLP) to output a zero-vector for all α; this initializes an entire DiT block as the identity function. As with the adaLN block, adaLNZero adds negligible Gflops to the model.

In some cases, DiT blocks in the DiT network are implemented using in-context conditioning, where vector embeddings of t and c are appended as two additional tokens in the input sequence, and after a final block, the network removes the two conditioning tokens from the sequence.

In some cases, DiT blocks in the DiT network include cross-attention blocks. The DiT network concatenates the embeddings of t and c into a length-two sequence, separate from the image token sequence. The transformer block is modified to include an additional multi-head cross-attention layer following the multi-head self-attention block.

In some cases, the DiT network includes a sequence of N DiT blocks, each operating at a hidden dimension size d. Following ViT, the DiT network uses standard transformer configs that jointly scale N, d and attention heads. In some examples, small(S), base (B), large (L), and extra large (XL) variants of model sizes are implemented. Small or base model sizes have N=12 layers of DiT blocks, large model sizes have 24 layers of DiT blocks, and extra large model sizes have 28 layers of DiT blocks.

After a final DiT block, the DiT network decodes the sequence of image tokens into an output noise prediction and an output diagonal covariance prediction. Both outputs have a shape equal to an original spatial input. A standard linear decoder is utilized to decode, wherein a final normalization layer (or adaptive normalization layer if the DiT block is an adaLN block) and linearly decode each token into a p×p×2C tensor, where C is a number of channels in the spatial input to the DiT network and p is the patch size hyperparameter. Finally, decoded tokens are rearranged into their original spatial layout to get the predicted noise and covariance.

In some embodiments, the DiT architecture 1300 employs a latent diffusion transformer 1394. The DiT architecture 1300 processes a noised latent 1340, which may be a noised version of an input image encoded in a latent space. The patchify operation 1330 divides the noised latent into a sequence of patches that are processed as tokens. The tokens are vector representations of each patch of the image in latent space and are adjusted through attention processes. Each of the tokens also receives timestep information 1345 and label information 1350 and, accordingly, their embedding 1335, which encodes the current denoising timestep and class labels as conditional information.

In some cases, embedding 1335 is referred to as a conditional embedding or a conditional information embedding. In some cases, a positional embedding that encodes a spatial position in the image of each token is applied to the patchified input tokens at the patchify operation 1330. In some examples, the positional embedding is a ViT frequency-based positional embedding. The input tokens 1380 generated by the patchify operation 1330 and the conditioning tokens 1382 generated by the embedding 1335 are processed through N DiT blocks 1325, where N may be 12, 24, or 28. Other values of N may be used. In some cases, a conditional token refers to a token generated based on embedding 1335 encoding timestep information 1345 and label information 1350.

Each of the DiT blocks 1325 includes multiple processing stages. DiT block 1396 illustrates an embodiment of one block in the DiT blocks 1325. In some embodiments, the DiT block 1396 is an example of, or includes aspects of, the adaLN-Zero block. In some cases, input tokens 1380 interact with the conditioning tokens 1382 through multiple attention mechanisms. Particularly, after first normalization 1378 is applied to the input tokens and MLP 1384 is applied to the conditional tokens, MLP 1384 generates or updates post-normalization first scaling and shifting parameters 1386, denoted as γ₁, β₁, for post-normalization first scaling and shifting 1376 to scale and shift the output of first normalization 1378 accordingly.

As the normalized input tokens obtained from first normalization 1378 are scaled and shifted at post-normalization first scaling and shifting 1376 using the conditional information carried as least in γ₁, β₁, this allows the input information and conditional information to interact. Self-attention 1374 allows the scaled and shifted normalized input tokens, namely the output from post-normalization first scaling and shifting 1376, to attend to each other. MLP 1384 also generates or updates first scaling parameter 1388, denoted as α₁, for first scaling operations 1372 to scale the output of self-attention 1374 (e.g., multi-head self-attention), further causing the input information and conditional information to interact. The input tokens 1380 are then summed with the output of first scaling operations 1372 at first residual connection 1370. In some examples, α₁ has initial values 0, and the DiT block 1396 is initialized as the identity function.

A similar process is performed in a second half of the DiT block 1396. MLP 1384 generates or updates post-normalization second scaling and shifting parameters 1390, denoted as γ₂, β₂, for post-normalization second scaling and shifting 1366 to scale and shift the output of second normalization 1368 accordingly. As the output from second normalization 1368 is scaled and shifted using the conditional information carried at least in γ₂, β₂, this allows the input information and conditional information to further interact.

Feed-forward network 1364 then processes the scaled and shifted output from post-normalization second scaling and shifting 1366. MLP 1384 also generates or updates second scaling parameter 1392, denoted as α₂, for second scaling operations 1362 to scale the output of feed-forward network 1364, further causing the input information and conditional information to interact. In some cases, the feed-forward network 1364 is a pointwise feed-forward network. The output from first residual connection 1370 is then summed with the output of second scaling operations 1362 at second residual connection 1360, and the result is the final output of DiT block 1396. In some examples, α₂ has initial values 0, and the DiT block 1396 is initialized as the identity function. This process repeats for each DiT block in the sequence.

After processing through all DiT blocks 1325, the outputs undergo normalization layer 1320 followed by linear and reshape layers 1315. The final output is the predicted noise 1305, which represents the model's prediction of the noise that was added to initially create the noised latent 1340, and the predicted covariance 1310, which represents the model's prediction of the covariance. The predicted noise 1305 is removed from noised latent 1340 at each diffusion timestep, and the predicted covariance may affect how noise is removed or resampled in the reverse or denoising process. At the end of the denoising schedule, the latent sample is decoded to generate the synthetic image in pixel space.

### Image Generation

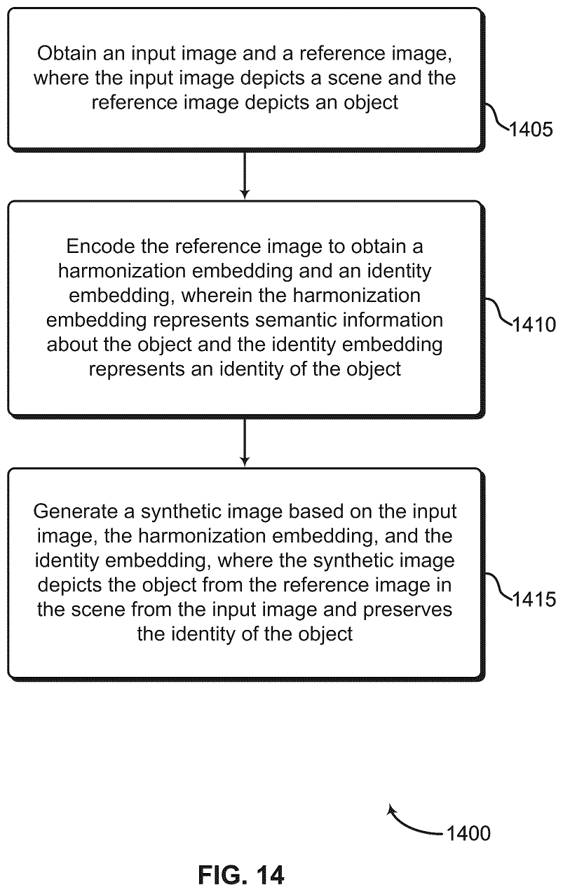

FIG. 14 shows an example of a method 1400 for generating a synthetic image based on a harmonization embedding and an identity embedding according to aspects of the present disclosure. Referring to FIG. 14, an image generation system (such as the image generation system of FIG. 1) uses an image generation model (such as the image generation model 2515 described with reference to FIG. 25) to generate a synthetic image based on an input image depicting a scene and a reference image depicting an object. The synthetic image depicts the object composited into the scene.

The image generation model generates the synthetic image based on a harmonization embedding and an identity embedding of the reference image. The harmonization embedding enables the image generation model to accurately composite the object into the scene in the synthetic image, while the identity embedding enables the image generation model to maintain a visual identity of the object in the synthetic image.

At operation 1405, the system obtains an input image and a reference image, where the input image depicts a scene and the reference image depicts an object. In some cases, the operations of this step refer to, or may be performed by, an image generation apparatus as described with reference to FIGS. 1, 24, and 25. In an example, a user provides the input image and the reference image to the image generation apparatus via a user interface as described with reference to FIG. 1. In some embodiments, the input image comprises a scene input image as described with reference to FIG. 9. In some embodiments, the input image comprises a masked input image as described with reference to FIG. 10. In some embodiments, the image generation apparatus obtains an input image mask. In some embodiments, the image generation apparatus obtains a noise map. In some embodiments, the input image, the input image mask, and the noise map include an equal number of pixels in height and in width.

At operation 1410, the system encodes the reference image to obtain a harmonization embedding and an identity embedding, wherein the harmonization embedding represents semantic information about the object and the identity embedding represents an identity of the object. In some cases, the operations of this step refer to, or may be performed by, a harmonization encoder and an identity encoder, respectively, as described with reference to FIGS. 9-11 and 18-19. In an example, the harmonization encoder generates the harmonization embedding and the identity encoder generates the identity embedding as described with reference to FIG. 9 or 10.

At operation 1415, the system generates, using an image generation model, a synthetic image based on the input image, the harmonization embedding, and the identity embedding, where the synthetic image depicts the object from the reference image in the scene from the input image and preserves the identity of the object. In some cases, the object is harmonized with the scene based on the harmonization embedding. For example the image generation model can depict a transformation of the object that is appropriate for the pose, lighting, and context of the scene based on the semantic information about the object encoded in the harmonization embedding. That is, the harmonization embedding can include information that guides the model in transforming the specific type of object. In some cases, the operations of this step refer to, or may be performed by, an image generation model as described with reference to FIGS. 1, 9-13, 18-19, and 25.

In an example, the image generation model generates the synthetic image as described with reference to FIG. 9 or 10. For example, the image generation model may generate the synthetic image using a reverse diffusion process which takes a concatenation of the input image, the input image mask, and the noise map as an input, where the reverse diffusion process is guided by the harmonization embedding and the identity embedding.

FIG. 15 shows an example of a diffusion process 1500 according to aspects of the present disclosure. In some examples, diffusion process 1500 describes an operation of the image generation model 2515 described with reference to FIG. 25, such as the reverse diffusion process described with reference to FIGS. 9-11.

As described above with reference to FIG. 15, using a diffusion model can involve both a forward diffusion process 1505 for adding noise to an image (or features in a latent space) and a reverse diffusion process 1510 for denoising the images (or features) to obtain a denoised image. The forward diffusion process 1505 can be represented as q(xₜ|xₜ₋₁), and the reverse diffusion process 1510 can be represented as p(xₜ₋₁|xₜ). In some cases, the forward diffusion process 1505 is used during training to generate images with successively greater noise, and a neural network is trained to perform the reverse diffusion process 1510 (i.e., to successively remove the noise).

In an example forward process for a latent diffusion model, the model maps an observed variable x₀ (either in a pixel space or a latent space) intermediate variables x₁, . . . , x_{T} using a Markov chain. The Markov chain gradually adds Gaussian noise to the data to obtain the approximate posterior q(x_{1:t}|x₀) as the latent variables are passed through a neural network such as a U-Net, where x₁, . . . , x_{T} have the same dimensionality as x₀.

The neural network may be trained to perform the reverse process. During the reverse diffusion process 1510, the model begins with noisy data x_{T}, such as a noisy image 1515, and denoises the data to obtain the p(xₜ₋₁|xₜ). At each step t−1, the reverse diffusion process 1510 takes xₜ, such as first intermediate image 1520, and t as input. Here, t represents a step in the sequence of transitions associated with different noise levels. The reverse diffusion process 1510 outputs xₜ₋₁, such as second intermediate image 1525 iteratively until x_{T} reverts back to x₀, the original image 1530. The reverse process can be represented as:

p_{θ}(xₜ₋₁|xₜ):=N(xₜ₋₁;μ_{θ}(xₜ,t),Σ_{θ}(xₜ,t)). (1)

The joint probability of a sequence of samples in the Markov chain can be written as a product of conditionals and the marginal probability:

$${x}_{T} : {p}_{θ} ( {x}_{0 : T} ) := p ( {x}_{T} ) {\prod }_{t = 1}^{T} {p}_{θ} ( {x}_{t - 1} \vert {x}_{t} ) , \qquad ( 2 )$$

where p(x_{T})=N(x_{T}; 0, I) is the pure noise distribution as the reverse process takes the outcome of the forward process, a sample of pure noise, as input and

$${\prod }_{t = 1}^{T} {p}_{θ} ( {x}_{t - 1} \vert {x}_{t} )$$

represents a sequence of Gaussian transitions corresponding to a sequence of addition of Gaussian noise to the sample.

At interference time, observed data x₀ in a pixel space can be mapped into a latent space as input and a generated data \tilde{x} is mapped back into the pixel space from the latent space as output. In some examples, x₀ represents an original input image with low image quality, latent variables x₁, . . . , x_{T} represent noisy images, and \tilde{x} represents the generated image with high image quality.

Accordingly, a method for image generation is described. One or more aspects of the method include obtaining an input image and a reference image, wherein the input image depicts a scene and the reference image depicts an object; encoding the reference image to obtain a harmonization embedding and an identity embedding, wherein the harmonization embedding represents semantic information about the object and the identity embedding represents an identity of the object; and generating, using an image generation model, a synthetic image based on the input image, the harmonization embedding, and the identity embedding, wherein the synthetic image depicts the object from the reference image in the scene from the input image and preserves the identity of the object.

Some examples of the method further include encoding the input image to obtain an input image embedding, wherein the synthetic image is generated based on the input image embedding. Some examples of the method further include obtaining an input image mask, wherein the synthetic image is generated based on the input image mask and depicts the object at a location indicated by the input image mask.

In some examples, generating the synthetic image includes obtaining a noise input and denoising the noise input based on the harmonization embedding and the identity embedding. In some examples, generating the synthetic image includes performing a cross-attention operation based on the harmonization embedding and the identity embedding.

In some aspects, the image generation model is trained to perform object compositing using a training set including a masked input image and a scene input image. In some aspects, the image generation model is trained to perform object compositing using a training set including a plurality of randomized mask shapes.

In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

### Training

FIG. 16 shows an example of a method 1600 for training a machine learning model according to aspects of the present disclosure. Referring to FIG. 16, a training component (such as the training component 2525 described with reference to FIG. 25) performs method 1600 to train an image generation model using both scene input images and masked input images. The image generation model therefore learns to generate a new scene or maintain a scene in a synthetic image in accordance with goals of a user.

At operation 1605, the system obtains a training set including a masked input image, a scene input image, and a reference image, where the reference image depicts an object. In some cases, the operations of this step refer to, or may be performed by, a training component as described with reference to FIG. 25. In an example, the training component retrieves the training set from a database, such as the database described with reference to FIG. 1.

At operation 1610, the system encodes the reference image to obtain a harmonization embedding and an identity embedding, wherein the harmonization embedding represents semantic information about the object and the identity embedding represents an identity of the object. In some cases, the operations of this step refer to, or may be performed by, a harmonization encoder and an identity encoder, respectively, as described with reference to FIGS. 9-11, and 18-19. In an example, the harmonization encoder generates the harmonization embedding and the identity encoder generates the identity embedding as described with reference to FIG. 9 or 10.

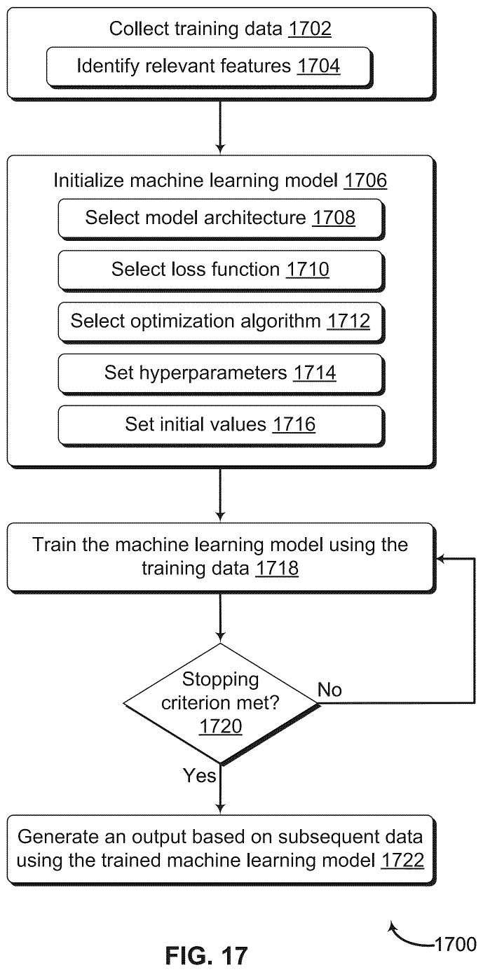

At operation 1615, the system trains, using the training set, an image generation model to generate a synthetic image based on the harmonization embedding and the identity embedding, wherein the synthetic image depicts the object from the reference image in a scene from the masked input image or the scene input image. In some cases, the operations of this step refer to, or may be performed by, a training component as described with reference to FIG. 25. In an example, the training component determines a loss function as described with reference to FIGS. 18 and 19 and updates the parameters of the image generation model based on the loss function as described with reference to FIGS. 17-23 and 25. In some embodiments, the training component updates the parameters of the identity encoder based on the loss function as described with reference to FIGS. 17-23 and 25.

According to some aspects, the training component updates the parameters of the image generation model (and in some embodiments the identity encoder) according to the loss function described with reference to FIG. 18 during a first training phase, and updates the parameters of the image generation model (and in some embodiments the identity encoder) according to the loss function described with reference to FIG. 19 during a second training phase.

FIG. 17 shows an example of a flow diagram depicting an algorithm as a step-by-step procedure 1700 for training a machine learning model according to aspects of the present disclosure. In some embodiments, the procedure 1700 describes an operation of the training component 2525 for configuring the image generation model 2515 described with reference to FIG. 25. In some embodiments, the procedure 1700 describes an operation of the training component for configuring the identity encoder described with reference to FIGS. 9-10 and 18-19. The procedure 1700 provides one or more examples of generating training data, use of the training data to train a machine learning model, and use of the trained machine learning model to perform a task.

To begin in this example, a machine learning system collects training data (block 1702) that is to be used as a basis to train a machine learning model, i.e., which defines what is being modeled. The training data is collectable by the machine learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine learning system is also configurable to identify features that are relevant (block 1704) to a type of task, for which the machine learning model is to be trained. Task examples include classification, natural language processing, generative artificial intelligence, recommendation engines, reinforcement learning, clustering, and so forth. To do so, the machine learning system collects the training data based on the identified features and/or filters the training data based on the identified features after collection. The training data is then utilized to train a machine learning model.

In order to train the machine learning model in the illustrated example, the machine learning model is first initialized (block 1706). Initialization of the machine learning model includes selecting a model architecture (block 1708) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 1710). The loss function is utilized to measure a difference between an output of the machine learning model (i.e., predictions) and target values (e.g., as expressed by the training data) to be used to train the machine learning model. Additionally, an optimization algorithm is selected (1712) that is to be used in conjunction with the loss function to optimize parameters of the machine learning model during training, examples of which include gradient descent, stochastic gradient descent (SGD), and so forth.

Initialization of the machine learning model further includes setting initial values of the machine learning model (block 1714) examples of which includes initializing weights and biases of nodes to improve efficiency in training and computational resources consumption as part of training. Hyperparameters are also set that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine learning model is then trained using the training data (block 1718) by the machine learning system. A machine learning model refers to a computer representation that can be tuned (e.g., trained and retrained) based on inputs of the training data to approximate unknown functions. In particular, the term machine learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine learning model to perform an associated task.

As part of training the machine learning model, a determination is made as to whether a stopping criterion is met (decision block 1720), i.e., which is used to validate the machine learning model. The stopping criterion is usable to reduce overfitting of the machine learning model, reduce computational resource consumption, and promote an ability of the machine learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 1720), the procedure 1700 continues training of the machine learning model using the training data (block 1718) in this example.

If the stopping criterion is met (“yes” from decision block 1720), the trained machine learning model is then utilized to generate an output based on subsequent data (block 1722). The trained machine learning model, for instance, is trained to perform a task as described above and therefore once trained is configured to perform that task based on subsequent data received as an input and processed by the machine learning model.

FIG. 18 shows an example of a training diagram for training an image generation model 1800 using a scene input image according to aspects of the present disclosure. The example shown includes image generation model 1800, noise 1820, scene input image 1825, input image mask 1830, reference image 1835, harmonization embedding 1840, identity embedding 1845, synthetic image 1850, ground-truth image 1855, and loss 1860. In one aspect, image generation model 1800 includes harmonization encoder 1805, identity encoder 1810, and reverse diffusion process 1815.

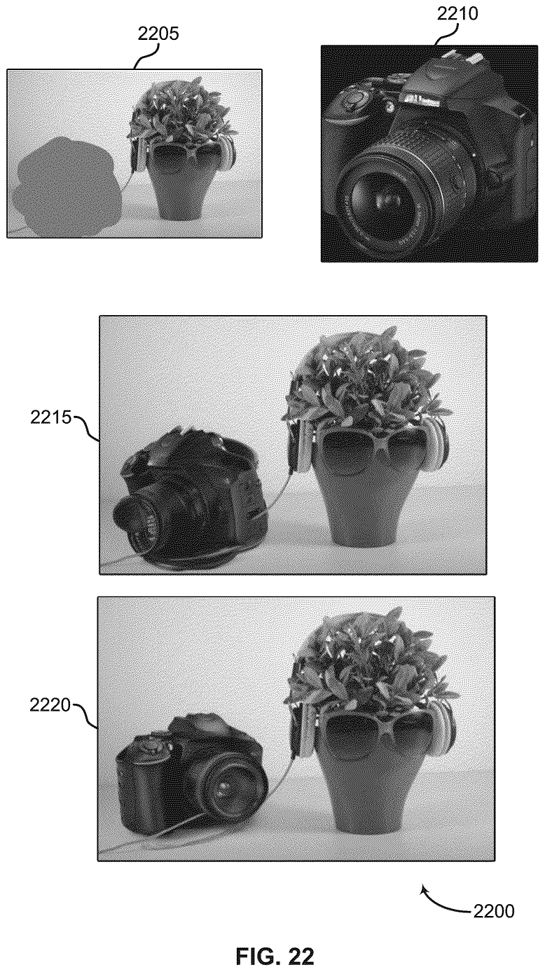

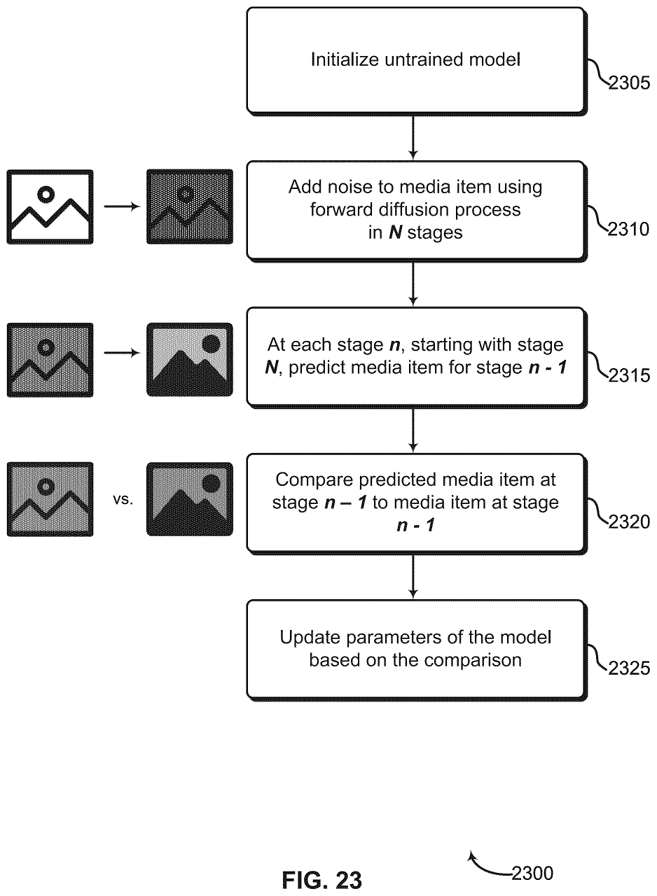

Referring to FIG. 18, during training, image generation model 1800 generates a synthetic image depicting an object composited into a scene (e.g., synthetic image 1850) based on noise (e.g., noise 1820), a scene input image depicting the scene (e.g., scene input image 1825), an input image mask (e.g., input image mask 1830), and a reference image depicting the object (e.g., reference image 1835) as described with reference to FIG. 9. A training component (e.g., the training component 2525 described with reference to FIG. 25) compares the synthetic image with a ground-truth image also depicting the scene and the object (e.g., ground-truth image 1855) to determine a loss (e.g., loss 1860). In some embodiments, the loss comprises a diffusion loss, such as one or more of a mean squared error (MSE) loss and an L1 or perceptual loss. The training component updates the parameters of image generation model 1800 based on the loss as described with reference to FIGS. 17 and 23. In some embodiments, the training component updates the parameters of identity encoder 1810 based on the loss as described with reference to FIGS. 17 and 22. In some embodiments, the scene input image and the reference image are generated based on the ground-truth image using an image extraction model as described with reference to FIG. 20.

Training image generation model 1800 using a scene input image allows image generation model 1800 to generate a synthetic image based on a scene input image and an input image mask such that the only synthetic pixels of the synthetic image correspond to the object.

Image generation model 1800 is an example of, or includes aspects of, the corresponding element described with reference to FIGS. 1, 9-13, 19, and 25. Harmonization encoder 1805 and identity encoder 1810 are examples of, or include aspects of, the corresponding elements described with reference to FIGS. 9-11 and 19. Reverse diffusion process 1815 is an example of, or includes aspects of, the corresponding element described with reference to FIGS. 9-13, 15, and 19-20.

Noise 1820, input image mask 1830, harmonization embedding 1840, and identity embedding 1845 are examples of, or include aspects of, the corresponding elements described with reference to FIGS. 9-10 and 19. Scene input image 1825 is an example of, or includes aspects of, the corresponding element described with reference to FIG. 9. Reference image 1835 is an example of, or includes aspects of, the corresponding element described with reference to FIGS. 1, 9-10, and 19. Synthetic image 1850 is an example of, or includes aspects of, the corresponding element described with reference to FIGS. 1, 9-10, and 19. Ground-truth image 1855 and loss 1860 are examples of, or include aspects of, the corresponding elements described with reference to FIG. 19.

FIG. 19 shows an example of a training diagram for training an image generation model 1900 using a masked input image according to aspects of the present disclosure. The example shown includes image generation model 1900, noise 1920, masked input image 1925, input image mask 1930, reference image 1935, harmonization embedding 1940, identity embedding 1945, synthetic image 1950, ground-truth image 1955, and loss 1960. In one aspect, image generation model 1900 includes harmonization encoder 1905, identity encoder 1910, and reverse diffusion process 1915.

Referring to FIG. 19, during training, image generation model 1900 generates a synthetic image depicting an object composited into a scene (e.g., synthetic image 1950) based on noise (e.g., noise 1920), a masked input image depicting the scene (e.g., masked input image 1925), an input image mask (e.g., input image mask 1930), and a reference image depicting the object (e.g., reference image 1935) as described with reference to FIG. 10. A training component (e.g., the training component 2525 described with reference to FIG. 25) compares the synthetic image with a ground-truth image also depicting the scene and the object (e.g., ground-truth image 1955) to determine a loss (e.g., loss 1960). The training component updates the parameters of image generation model 1900 based on the loss as described with reference to FIGS. 17 and 23. In some embodiments, the training component updates the parameters of identity encoder 1910 based on the loss as described with reference to FIGS. 17 and 23. In some embodiments, the scene input image and the reference image are generated based on the ground-truth image using an image extraction model as described with reference to FIG. 20.

Training image generation model 1900 using a masked input image allows image generation model 1900 to generate a synthetic image based on a masked input image and an input image mask such that some of the synthetic pixels of the synthetic image correspond to the object and some of the synthetic pixels of the synthetic image correspond to the scene.

Image generation model 1900 is an example of, or includes aspects of, the corresponding element described with reference to FIGS. 1, 9-13, 18, and 25. Harmonization encoder 1905 and identity encoder 1910 are examples of, or include aspects of, the corresponding elements described with reference to FIGS. 9-11 and 18. Reverse diffusion process 1915 is an example of, or includes aspects of, the corresponding element described with reference to FIGS. 9-13, 15, 18, and 20.

Noise 1920 is an example of, or includes aspects of, the corresponding element described with reference to FIGS. 9-11 and 18. Masked input image 1925 is an example of, or includes aspects of, the corresponding element described with reference to FIGS. 1, 10, and 22. Input image mask 1930, harmonization embedding 1940, and identity embedding 1945 are examples of, or include aspects of, the corresponding elements described with reference to FIGS. 9-10 and 18. Reference image 1935 is an example of, or includes aspects of, the corresponding element described with reference to FIGS. 1, 9-10, 18, and 22. Synthetic image 1950 is an example of, or includes aspects of, the corresponding element described with reference to FIGS. 1, 9-10, and 18. Ground-truth image 1955 is an example of, or includes aspects of, the corresponding element described with reference to FIG. 22. Loss 1960 is an example of, or includes aspects of, the corresponding element described with reference to FIG. 18.

FIG. 20 shows an example of an image extraction model 2000 according to aspects of the present disclosure. The example shown includes image extraction model 2000, ground-truth image 2005, object mask 2010, encoder 2015, ground-truth image features 2020, composite type embedding 2025, mask features 2030, mask type embedding 2035, second noisy embedding 2040, background type embedding 2045, first noisy embedding 2050, foreground type embedding 2055, intermediate features 2060, diffusion transformer 2065, background features 2070, foreground features 2075, second decoder 2080, first decoder 2085, input image 2090, and reference image 2095.

Referring to FIG. 20, image extraction model 2000 is an image generation model (e.g., a diffusion model) implemented according to the guided latent diffusion model 1100 described with reference to FIG. 11. According to some aspects, image extraction model 2000 comprises machine learning parameters stored in a memory unit 2510 of the image generation apparatus 2500 described with reference to FIG. 25. Image extraction model 2000 is used to extract a reference image (e.g., reference image 2095) and an input image (e.g., input image 2090) from a ground-truth image (e.g., ground-truth image 2005) to generate a training data set for training an image generation model as described with reference to FIGS. 18 and 19.

Image extraction model 2000 obtains conditional input and noisy latent. In some embodiments, the conditional input includes ground-truth image 2005 and object mask 2010, while the noisy latent includes first noisy embedding 2050 and second noisy embedding 2040. Ground-truth image 2005, depicting an object in a scene, is encoded by encoder 2015 to obtain ground-truth image features 2020, and object mask 2010 is encoded by encoder 2015 to obtain mask features 2030. The ground-truth image features 2020, mask features 2030, first noisy embedding 2050 and second noisy embedding 2040, being patch embeddings (e.g. vectors in a latent space), are further combined with corresponding type embeddings to form intermediate features 2060. In an embodiment, to obtain intermediate features 2060, image extraction model 2000 combines ground-truth image features 2020 with composite type embedding 2025, mask features 2030 with mask type embedding 2035, first noisy embedding 2050 with foreground type embedding 2055, and second noisy embedding 2040 with background type embedding 2045.

In some embodiments, the intermediate features 2060 are fed as input to diffusion transformer 2065. Image extraction model 2000 uses diffusion transformer 2065 to performing a reverse diffusion process (such as the reverse diffusion process 1510 described with reference to FIG. 15) to generate foreground features 2075 and background features 2070. Image extraction model 2000 decodes the foreground features 2075 using first decoder 2085 (such as an RGBA decoder) to generate reference image 2095. Image extraction model 2000 decodes the background features 2070 using second decoder 2080 (e.g. an RGB decoder) to generate input image 2090. Reference image 2095 depicts the object separate from the scene, and the input image 2090 depicts the scene without the object. In some cases, the input image 2090 includes synthetic content in a location occupied by the object in the ground-truth image 2005, making the input image 2090 integral, complete, and natural in terms of visual effects.

Encoder 2015 is an example of, or includes aspects of, the corresponding element described with reference to FIG. 11. In one or more embodiments, the encoder 2015 includes a Variational Autoencoder (VAE) encoder with RGB channels and is configured to encode the ground-truth image 2005 to obtain ground-truth image features 2020, and to encode the object mask 2010 to obtain mask features 2030. In some examples, the encoder 2015 is denoted as

$${g}_{ϕ}^{RGB} ( \cdot ) .$$

Diffusion transformer 2065 is an example of, or includes aspects of, the corresponding element described with reference to FIG. 13. In some examples, diffusion transformer 2065 is denoted as fθ(·), where θ is some trainable parameter(s). Diffusion transformer 2065 or f_{θ}(·) takes two types of conditional image embeddings c=(y_{comp}, y_{obj}), which are the latents of the original composite image, and the decomposition object mask, respectively, i.e.,

$$c = ( {y}_{comp} , {y}_{obj} ) = ( {g}_{ϕ}^{RGB} ( {I}_{comp}^{RGB} ) , {g}_{ϕ}^{RGB} ( {M}_{obj} ) ) .$$

In some embodiments, y_{comp} denotes the ground-truth image features 2020 obtained by running or evaluating encoder 2015

$$( {g}_{ϕ}^{RGB} ( \cdot ) )$$

on the ground-truth image 2005

$$( {I}_{comp}^{RGB} ) ,$$

and y_{obj} denotes the mask features 2030 obtained by running or evaluating encoder 2015

$$( {g}_{ϕ}^{R G B} ( \cdot ) )$$

on the object mask 2010 (M_{obj}). In some examples, such as the example shown, object mask 2010 includes a set of object masks, where at least one of the set of object masks indicates a location of the object in the ground-truth image 2005, and at least one of the set of object masks indicates the location of the object in the ground-truth image 2005 and a location of a shadow or reflection of the object in the ground-truth image 2005.

By taking the conditional image embeddings c=(y_{comp}, y_{obj}), the model f_{θ}(·) (diffusion transformer 2065) targets to denoise a noisy latent

$${x}_{t} = ( {x}_{t}^{bg} , {x}_{t}^{fg} ) ,$$

to recover the latent of the clean input image and the transparent foreground layer

$${x}_{0} = ( {x}_{0}^{bg} , {x}_{0}^{fg} ) = ( {g}_{ϕ}^{RGB} ( {I}_{bg}^{RGB} ) , {g}_{ψ}^{RGBA} ( {I}_{fg}^{RGBA} ) ) .$$

In some embodiments, image extraction model 2000 further includes an encoder

$$( {g}_{ψ}^{RGBA} ( \cdot ) )$$

configured to encode a reference image

$$( {I}_{fg}^{RGBA} ) .$$

In some cases,

$${g}_{ψ}^{RGBA} ( \cdot ) )$$

is an RGBA-VAE fine-tuned from original VAE that makes minimal disturbance to original latent space. The reference image

$$( {I}_{fg}^{RGBA} )$$

comprises an α-channel (A) indicating a transparency value outside of a location occupied by a foreground object in the input image. The α-channel is typically represented as a matrix of shape consistent with the synthetic reference image, the matrix having as entries real numbers between 0 and 1, inclusive.

In some embodiments, diffusion transformer 2065 is trained using a training loss following a standard denoising diffusion loss:

$${ℒ}_{dm} = {𝔼}_{t ∼ 𝒰 ( \{ 1 , … , T \} ) , ϵ , {x}_{t}} [ {‖ {ϵ}_{θ} ( {x}_{t} ; c , t ) - ϵ ‖}_{2}^{2} ] \qquad ( 3 )$$

x₀~q_{data}(x₀), ϵ~ [symbol] (0, I), xₜ~\sqrt{αₜ}x₀+\sqrt{1−αₜ} ϵ. Here [symbol] (0, I) denotes normal distribution with mean value 0 and standard deviation 1, and q_{data}(x₀) is a data distribution. ϵₑ is a time-variant noise based on the conditional input embeddings c=(y_{comp}, y_{obj}) parametrized by θ.

In some embodiments, image extraction model 2000 obtains first noisy embedding 2050 and second noisy embedding 2040. First noisy embedding 2050, second noisy embedding 2040, the ground-truth image features 2020 (y_{comp}), and the mask features 2030 (y_{obj}) indicating a location of the object in the ground-truth image 2005 are patch embeddings that are each combined with a corresponding type embedding and then concatenated into a sequence (intermediate features 2060). In an embodiment, to obtain intermediate features 2060, image extraction model 2000 combines ground-truth image features 2020 (y_{comp}) with composite type embedding 2025, mask features 2030 (y_{obj}) with mask type embedding 2035, first noisy embedding 2050 with foreground type embedding 2055, and second noisy embedding 2040 with background type embedding 2045.

Intermediate features 2060 are then processed through multiple transformer blocks as described with reference to FIG. 13. With such design, the image conditions as represented by conditional image embeddings and further combined with type embeddings to form intermediate features 2060 provide comprehensive contextual information through the self-attention in the transformer blocks to enhance the denoising performed by diffusion transformer 2065, and the standard denoising diffusion loss [symbol] _{dm} is only computed on the positions corresponding to the noisy latent. As such, a computational efficiency of image extraction model 2000 is increased. In some examples, where ground-truth image

$$( {I}_{comp}^{RGB} )$$

comprises real-world camera captured data, the noisy input and output corresponding to the foreground are masked out from [symbol] _{dm} computation if

$${I}_{fg}^{R G B A}$$

is absent at the training stage. Real-world data enhances an ability of image extraction model 2000 to generalize to natural images containing authentic shadows and a broader range of visual effects, such as reflections, which facilitates accurate foreground-background decomposition in real-world tasks.

In some cases where real-world data lacks ground-truth annotations, image extraction model 2000 or specifically the diffusion transformer 2065 is trained using a consistency loss that enables the learning of natural visual effects in the transparent foreground layer without explicit annotation. Intuitively, the consistency loss is applied in the decoded pixel space to encourage the predicted foreground to faithfully reconstruct the composite input after blending with the background layers.

More specifically, given a composite image

$${I}_{c o m p}^{R G B} ,$$

at any denoising timestep t, the model prediction is parameterized back to the estimation of the clean latent x₀ as:

$${\hat{x}}_{0} ( {x}_{t} ; c , t ) = \frac{1}{\sqrt{{α}_{t}}} ( {x}_{t} - \sqrt{1 - {α}_{t}} \cdot {ϵ}_{θ} ( {x}_{t} ; c , t ) ) \qquad ( 4 )$$

Given Equation 4, the estimated

$${\hat{x}}_{0} ( {x}_{t} ; c , t ) = ( {\hat{x}}_{0}^{bg} , {\hat{x}}_{0}^{fg} )$$

of background and foreground at time step t is computed and are decoded into pixel space to get

$${\hat{I}}_{bg}^{R G B} = {h}_{{ϕ}^{′}}^{R G B} ( {\hat{x}}_{0}^{bg} ) and {\hat{I}}_{fg}^{R G B A} = {h}_{{ψ}^{′}}^{R G B A} ( {\hat{x}}_{0}^{fg} ) ,$$

a decoder of

$$RGB - VAE ( {h}_{{ϕ}^{′}}^{R G B} ( \cdot ) ,$$

i.e. second decoder 2080) and a decoder of

$$RGBA - VAE ( , {h}_{{ψ}^{′}}^{R G B A} ( \cdot ) ,$$

i.e. first decoder 2085), respectively. The results are combined through α-blending to produce the estimated composite image

$${\hat{I}}_{comp}^{R G B} = 𝒜 ( {\hat{I}}_{bg}^{R G B} , {\hat{I}}_{fg}^{R G B A} ) .$$

$$( {\hat{I}}_{fg}^{R G B A} )$$

output

$$( {\hat{I}}_{bg}^{R G B} )$$

are used to recombine the foreground output and background in the α-blending process [symbol] (·). In some examples, a larger value (e.g. closer to 1 in cases where entries are in [0,1]⊂ [symbol] ) in an entry of the α-channel indicates a higher weight or more significant contribution of the synthetic foreground layer in the composite image

$${\hat{I}}_{comp}^{R G B}$$

formed by α-blending [symbol] (·).

The consistency loss (e.g. used to train diffusion transformer 2065) is accordingly defined as:

$${ℒ}_{consist} = {𝔼}_{t} {\sum }_{i = 1}^{H} {\sum }_{j = 1}^{W} \vert {I}_{comp}^{R G B} ( i , j ) - {\hat{I}}_{comp}^{R G B} ( i , j ) \vert \qquad ( 5 )$$

H and W indicate the height and the width of the composite image, respectively. The consistency loss enables image extraction model 2000 to learn faithful representations of transparent visual effects in the foreground layer, which helps to accurately decompose natural shadows and reflections in real-world data, especially in the absence of annotations.

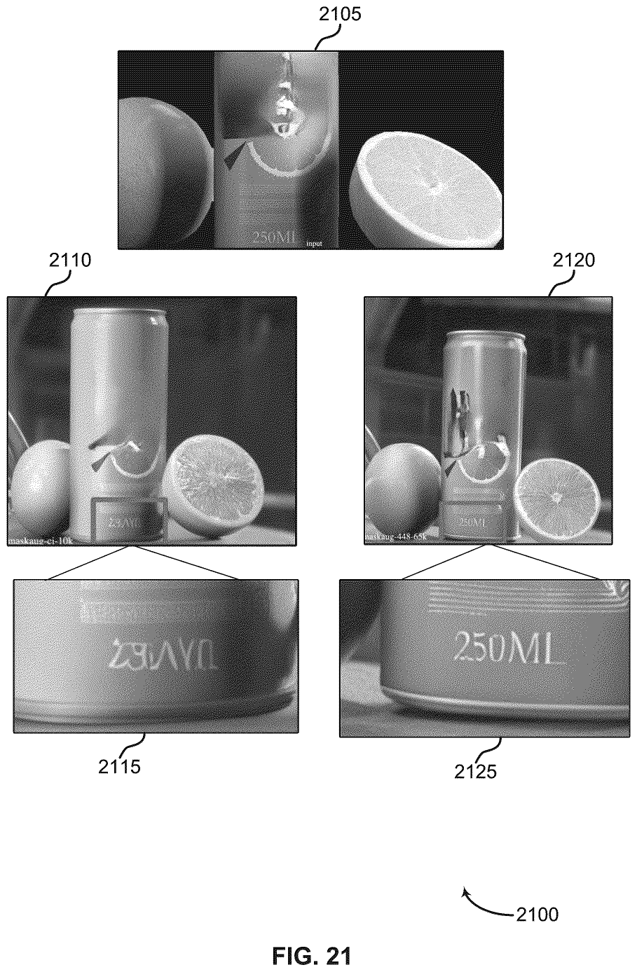

FIG. 21 shows a comparative example 2100 of an image generated based on a fine-tuned identity encoder according to aspects of the present disclosure. The example shown includes input image 2105, first synthetic image 2110, and second synthetic image 2120. First synthetic image 2110 includes first inset 2115. Second synthetic image 2120 includes second inset 2125.

Referring to FIG. 21, in some embodiments, the identity encoder described with reference to FIGS. 18 and 19 comprises a pre-trained identity encoder, where the pre-trained identity encoder is trained on a low-resolution (e.g., 224×224) image. According to some aspects, the identity encoder receives a high-resolution (e.g., 448×448) reference image as input, a loss is generated as described with reference to FIGS. 18 and 19 based on the high-resolution reference image, and the identity encoder is further trained (e.g., fine-tuned) according to the loss. In some embodiments, the identity encoder is trained together with the reverse diffusion process at a lower learning rate for stable training.

First synthetic image 2110 is an example of an image generated by an image generation model based on an embedding of input image 2105 generated by the pre-trained identity encoder, and second synthetic image 2120 is an example of an image generated by the image generation model based on an embedding of input image 2105 generated by the fine-tuned identity encoder. Second inset 2125 shows that second synthetic image depicts detail (the text “250 ML”) that is accurate to input image 2105, while first inset 2115 shows that first synthetic image 2110 fails to accurately depict the same detail.

FIG. 22 shows an example 2200 of the effect of mask randomization during training according to aspects of the present disclosure. The example shown includes initial masked input image 2205, reference image 2210, first image 2215, and second image 2220.

According to some aspects, a perimeter shape of the input image mask described with reference to FIGS. 18 and/or 19 (and the corresponding masked region in the masked input image described with reference to FIG. 19) is randomized, such that a first synthetic image is generated based on an initial mask shape, and a second synthetic image is generated based on a second mask shape (achieved by techniques such as overlying random masks on top of the initial mask, random brush strokes, etc.). First image 2215 is an example of a synthetic image generated based on initial masked input image 2205 and reference image 2210 (e.g., a reference image as described with reference to FIG. 18 or 19) without such mask randomization, and second image 2220 is an example of a synthetic image generated based on initial masked input image 2205, one or more additional random mask shapes for initial masked input image 2205, and reference image 2210 using mask randomization.

Second image 2220 accurately depicts the camera depicted in reference image 2210, while first image 2215 distorts the camera and fails to accurately harmonize the camera with the scene depicted in initial masked input image 2205. Therefore, according to some aspects, mask randomization during training increases an accuracy of the depiction of the object in a synthetic image.

FIG. 23 shows an example of a method 2300 for training a diffusion model according to aspects of the present disclosure. In some embodiments, the method 2300 describes an operation of the training component 2525 described for configuring the image generation model 2515 described with reference to FIG. 25. The method 2300 represents an example for training a reverse diffusion process as described above with reference to FIGS. 11 and 15. In some examples, these operations are performed by a system including a processor executing a set of codes to control functional elements of an apparatus.

Additionally or alternatively, certain processes of method 2300 may be performed using special-purpose hardware. Generally, these operations are performed according to the methods and processes described in accordance with aspects of the present disclosure. In some cases, the operations described herein are composed of various substeps or are performed in conjunction with other operations.

At operation 2305, the user initializes an untrained model. Initialization can include defining the architecture of the model and establishing initial values for the model parameters. In some cases, the initialization can include defining hyper-parameters such as the number of layers, the resolution and channels of each layer blocks, the location of skip connections, and the like.

At operation 2310, the system adds noise to a training image using a forward diffusion process in N stages. In some cases, the forward diffusion process is a fixed process where Gaussian noise is successively added to an image. In latent diffusion models, the Gaussian noise may be successively added to features in a latent space.

At operation 2315, the system at each stage n, starting with stage N, a reverse diffusion process is used to predict the image or image features at stage n−1. For example, the reverse diffusion process can predict the noise that was added by the forward diffusion process, and the predicted noise can be removed from the image to obtain the predicted image. In some cases, an original image is predicted at each stage of the training process.

At operation 2320, the system compares predicted image (or image features) at stage n−1 to an actual image (or image features), such as the image at stage n−1 or the original input image. For example, given observed data x, the diffusion model may be trained to minimize the variational upper bound of the negative log-likelihood −log p_{θ}(x) of the training data.

At operation 2325, the system updates parameters of the model based on the comparison. For example, parameters of a U-Net may be updated using gradient descent. Time-dependent parameters of the Gaussian transitions can also be learned.

Accordingly, a method for training a machine learning model is described. One or more aspects of the method include obtaining a training set including a masked input image, a scene input image, and a reference image, wherein the reference image depicts an object; encoding the reference image to obtain a harmonization embedding and an identity embedding, wherein the harmonization embedding represents semantic information about the object and the identity embedding represents an identity of the object; and training, using the training set, an image generation model to generate a synthetic image based on the harmonization embedding and the identity embedding, wherein the synthetic image depicts the object from the reference image in a scene from the masked input image or the scene input image.

In some aspects, the training set includes a plurality of randomized mask shapes. In some aspects, the synthetic image depicts the scene from the masked input image and additional synthetic content based on the scene from the masked input image in a masked region of the masked input image. In some aspects, the synthetic image depicts the scene from the scene input image and includes content from the scene input image in a region corresponding to an input image mask.

In some aspects, the reference image is encoded using an identity encoder to obtain the identity embedding. Some examples of the method further include training the identity encoder with the image generation model.

In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

### Image Generation Apparatus

FIG. 24 shows an example of a computing device 2400 according to aspects of the present disclosure. The computing device 2400 may be an example of the image generation apparatus described with reference to FIGS. 1 and 25. In one aspect, computing device 2400 includes processor(s) 2405, memory subsystem 2410, communication interface 2415, I/O interface 2420, user interface components 2425, and channel 2430.

In some embodiments, computing device 2400 is an example of, or includes aspects of, the image generation model 2515 of FIG. 25. In some embodiments, computing device 2400 includes one or more processors 2405 that can execute instructions stored in memory subsystem 2410 to perform image generation.

According to some aspects, computing device 2400 includes one or more processors 2405. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 2410 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 2415 operates at a boundary between communicating entities (such as computing device 2400, one or more user devices, a cloud, and one or more databases) and channel 2430 and can record and process communications. In some cases, communication interface 2415 is provided to enable a processing system coupled to a transceiver (e.g., a transmitter and/or a receiver). In some examples, the transceiver is configured to transmit (or send) and receive signals for a communications device via an antenna.

According to some aspects, I/O interface 2420 is controlled by an I/O controller to manage input and output signals for computing device 2400. In some cases, I/O interface 2420 manages peripherals not integrated into computing device 2400. In some cases, I/O interface 2420 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 2420 or via hardware components controlled by the I/O controller.

According to some aspects, user interface components 2425 enable a user to interact with computing device 2400. In some cases, user interface components 2425 include an audio device, such as an external speaker system, an external display device such as a display screen, an input device (e.g., a remote-control device interfaced with a user interface directly or through the I/O controller), or a combination thereof. In some cases, user interface components 2425 include a GUI.

FIG. 25 shows an example of an image generation apparatus 2500 according to aspects of the present disclosure. Image generation apparatus 2500 is an example of, or includes aspects of, the corresponding element described with reference to FIGS. 1 and 24. Image generation apparatus 2500 may include an example of, or aspects of, the image generation model described with reference to FIGS. 9-11 and 18-19. In some embodiments, image generation apparatus 2500 includes processor unit 2505, memory unit 2510, image generation model 2515, I/O module 2520, and training component 2525. Training component 2525 updates parameters of the image generation model 2515 stored in memory unit 2510. In some examples, the training component 2525 is located outside the image generation apparatus 2500.

Processor unit 2505 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

In some cases, processor unit 2505 is configured to operate a memory array using a memory controller. In other cases, a memory controller is integrated into processor unit 2505. In some cases, processor unit 2505 is configured to execute computer-readable instructions stored in memory unit 2510 to perform various functions. In some aspects, processor unit 2505 includes special purpose components for modem processing, baseband processing, digital signal processing, or transmission processing. According to some aspects, processor unit 2505 comprises one or more processors 2405 described with reference to FIG. 24.

Memory unit 2510 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 2505 to perform various functions described herein.

In some cases, memory unit 2510 includes a basic input/output system (BIOS) that controls basic hardware or software operations, such as an interaction with peripheral components or devices. In some cases, memory unit 2510 includes a memory controller that operates memory cells of memory unit 2510. For example, the memory controller may include a row decoder, column decoder, or both. In some cases, memory cells within memory unit 2510 store information in the form of a logical state. According to some aspects, memory unit 2510 is an example of the memory subsystem 2410 described with reference to FIG. 24.

According to some aspects, image generation apparatus 2500 uses one or more processors of processor unit 2505 to execute instructions stored in memory unit 2510 to perform functions described herein. For example, the image generation apparatus 2500 may perform operation comprising obtaining an input image and a reference image, wherein the input image depicts a scene and the reference image depicts an object; encoding the reference image to obtain a harmonization embedding and an identity embedding, wherein the harmonization embedding represents semantic information about the object and the identity embedding represents an identity of the object; and generating, using image generation model 2515, a synthetic image based on the input image, the harmonization embedding, and the identity embedding, wherein the synthetic image depicts the object from the reference image in the scene from the input image and preserves the identity of the object.

The memory unit 2510 may include an image generation model 2515 trained to generate a synthetic image based on a harmonization embedding and an identity embedding. For example, after training, the image generation model 2515 may perform inferencing operations as described with reference to FIGS. 14-15 to generate the synthetic image.

Image generation model 2515 is an example of, or includes aspects of, the image generation model described with reference to FIGS. 1, 9-13, and 18-19. In some embodiments, the image generation model 2515 is an artificial neural network (ANN) such as the diffusion model described with reference to FIGS. 9-13 and 18-19. An ANN can be a hardware component or a software component that includes connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

ANNs have numerous parameters, including weights and biases associated with each neuron in the network, which control the degree of connection between neurons and influence the neural network's ability to capture complex patterns in data. These parameters, also known as model parameters or model weights, are variables that determine the behavior and characteristics of a machine learning model.

In some cases, the signals between nodes comprise real numbers, and the output of each node is computed by a function of its inputs. For example, nodes may determine their output using other mathematical algorithms, such as selecting the max from the inputs as the output, or any other suitable algorithm for activating the node. Each node and edge are associated with one or more node weights that determine how the signal is processed and transmitted. In some cases, nodes have a threshold below which a signal is not transmitted at all. In some examples, the nodes are aggregated into layers.

The parameters of the image generation model 2515 can be organized into layers. Different layers perform different transformations on their inputs. The initial layer is known as the input layer and the last layer is known as the output layer. In some cases, signals traverse certain layers multiple times. A hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

Training component 2525 may train the image generation model 2515. For example, parameters of the image generation model 2515 can be learned or estimated from training data and then used to make predictions or perform tasks based on learned patterns and relationships in the data. In some examples, the parameters are adjusted during the training process to minimize a loss function or maximize a performance metric (e.g., as described with reference to FIGS. 16-23). The goal of the training process may be to find optimal values for the parameters that allow the image generation model 2515 to make accurate predictions or perform well on the given task.

Accordingly, the node weights can be adjusted to improve the accuracy of the output (i.e., by minimizing a loss which corresponds in some way to the difference between the current result and the target result). The weight of an edge increases or decreases the strength of the signal transmitted between nodes. For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the image generation model 2515 can be used to make predictions on new, unseen data (i.e., during inference).

I/O module 2520 receives inputs from and transmits outputs of the image generation apparatus 2500 to other devices or users. For example, I/O module 2520 receives inputs for the image generation model 2515 and transmits outputs of the image generation model 2515. According to some aspects, I/O module 2520 is an example of the I/O interface 2420 described with reference to FIG. 24.

According to some aspects, training component 2525 comprises software stored in memory unit 2510, firmware, one or more hardware circuits, or a combination thereof.

The description and drawings described herein represent example configurations and do not represent all the implementations within the scope of the aspects. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein but is to be accorded the broadest scope consistent with the principles and novel features disclosed herein.

The described methods may be implemented or performed by devices that include a general-purpose processor, a digital signal processor (DSP), an application-specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following aspects, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method for image generation, comprising:
obtaining an input image and a reference image, wherein the input image depicts a scene and the reference image depicts an object;
encoding the reference image to obtain a harmonization embedding and an identity embedding, wherein the harmonization embedding represents semantic information about the object and the identity embedding represents an identity of the object; and
generating, using an image generation model, a synthetic image based on the input image, the harmonization embedding, and the identity embedding, wherein the synthetic image depicts the object from the reference image in the scene from the input image, wherein the object is harmonized with the scene based on the harmonization embedding, and wherein the synthetic image preserves the identity of the object.

2. The method of claim 1, further comprising:
encoding the input image to obtain an input image embedding, wherein the synthetic image is generated based on the input image embedding.

3. The method of claim 1, further comprising:
obtaining an input image mask, wherein the synthetic image is generated based on the input image mask and depicts the object at a location indicated by the input image mask.

4. The method of claim 1, wherein generating the synthetic image comprises:
obtaining a noise input; and
denoising the noise input based on the harmonization embedding and the identity embedding.

5. The method of claim 1, wherein generating the synthetic image comprises:
performing a cross-attention operation based on the harmonization embedding and the identity embedding.

6. The method of claim 1, wherein:
the image generation model is trained to perform object compositing using a training set including a masked input image and a scene input image.

7. The method of claim 1, wherein:
the image generation model is trained to perform object compositing using a training set including a plurality of randomized mask shapes.

8. A method for training a machine learning model, the method comprising:
obtaining a training set including a scene input image and a reference image, wherein the reference image depicts an object;
encoding the reference image to obtain a harmonization embedding and an identity embedding, wherein the harmonization embedding represents semantic information about the object and the identity embedding represents an identity of the object; and
training, using the training set, an image generation model to generate a synthetic image based on the harmonization embedding and the identity embedding, wherein the synthetic image depicts the object from the reference image in a scene from the scene input image.

9. The method of claim 8, wherein:
the training set includes a plurality of randomized mask shapes.

10. The method of claim 8, wherein:
the synthetic image depicts the scene from the scene input image and additional synthetic content based on the scene from in a masked region of the scene input image.

11. The method of claim 8, wherein:
the synthetic image depicts the scene from the scene input image and includes content from the scene input image in a region corresponding to an input image mask.

12. The method of claim 8, wherein:
the reference image is encoded using an identity encoder to obtain the identity embedding.

13. The method of claim 12, further comprising:
training the identity encoder with the image generation model.

14. A system comprising:
a memory component; and
a processing device coupled to the memory component, the processing device configured to perform operations comprising:
obtaining an input image and a reference image, wherein the input image depicts a scene and the reference image depicts an object;
encoding the reference image to obtain a harmonization embedding and an identity embedding, wherein the harmonization embedding represents semantic information about the object and the identity embedding represents an identity of the object; and
generating, using an image generation model, a synthetic image based on the input image, the harmonization embedding, and the identity embedding, wherein the synthetic image depicts the object from the reference image in the scene from the input image, wherein the object is harmonized with the scene based on the harmonization embedding, and wherein the synthetic image preserves the identity of the object.

15. The system of claim 14, wherein:
a harmonization encoder configured to encode the reference image to obtain the harmonization embedding.

16. The system of claim 15, wherein:
the harmonization encoder comprises an image encoder trained together with a text encoder.

17. The system of claim 14, wherein:
an identity encoder configured to encode the reference image to obtain the identity embedding.

18. The system of claim 17, wherein:
the identity encoder comprises a vision transformer.

19. The system of claim 17, wherein:
the identity encoder is trained together with the image generation model.

20. The system of claim 14, wherein:
the image generation model comprises a diffusion transformer.
